(19) United States
(12) Patent Application Publication
(10) Pub. No.: US 2026/0349367 A1
(43) Pub. Date: Nov. 5, 2026

(54) DEVELOPING DEVICE AND IMAGE FORMING APPARATUS

(71) Applicant: KYOCERA Document Solutions Inc., Osaka (JP)

(72) Inventors: Tamotsu SHIMIZU, Osaka (JP); Asami SASAKI, Osaka (JP); Ayano IKEMURA, Osaka (JP)

(73) Assignee: KYOCERA Document Solutions Inc., Osaka (JP)

(21) Appl. No.: 19/651,566

(22) Filed: Apr. 17, 2026

(30) Foreign Application Priority Data
Apr. 25, 2025 (JP) 2025-073481

(51) Int. Cl. G03G 15/08

(52) U.S. Cl. CPC G03G 15/0818; G03G 15/0815; G03G 2215/0607

(57) ABSTRACT

Supposing that position P represents a position at which a ratio of a resultant force of a vertical magnetic force and a horizontal magnetic force of a developer separating part becomes maximum, and that position Q represents an intermediate position between positions Q1 and Q2, and that a distance of the magnetic force reversal region is α, and that a distance between positions Q1 and Q2 is β, and that a distance between positions P and Q is γ, and that γ has a positive value when position Q is on the upstream side of position P in the rotation direction, and that γ has a negative value when position Q is on the downstream side of position P in the rotation direction, then the following inequality (F1) is satisfied.

α−(18.9×(γ/β)²+20.8×(γ/β))>6 (F1)

### INCORPORATION BY REFERENCE

This application is based upon and claims the benefit of priority from the corresponding Japanese Patent Application No. 2025-073481 filed Apr. 25, 2025, the entire contents of which are hereby incorporated by reference.

### BACKGROUND

The present disclosure relates to a developing device and an image forming apparatus.

Conventionally, a developing device is known which uses a two-component developer so as to perform development.

The conventional developing device stirs the developer in its casing, carries the developer on a developing roller, and supplies toner from the developing roller to an electrostatic latent image. In this way, the electrostatic latent image is developed into a toner image.

### SUMMARY

A developing device according to a first aspect of the present disclosure includes a developing roller having a developer carrying surface for carrying a two-component developer containing toner particles and carrier particles, and supplies the toner particles in the two-component developer carried on the developer carrying surface to an electrostatic latent image, at a development position, so as to develop the electrostatic latent image. The developing roller includes a shaft, a magnet, and a development sleeve. The shaft extends in a predetermined direction. The magnet is fixed to an outer peripheral surface of the shaft, and has a plurality of magnetic poles in a circumferential direction of the shaft. The development sleeve is a cylindrical member in which the shaft is inserted, having an outer peripheral surface of the cylindrical member as the developer carrying surface, and is supported in a rotatable manner about the shaft. The magnet includes at least a first magnetic pole and a second magnetic pole as the magnetic poles. The first magnetic pole is disposed on a downstream side of the development position in a rotation direction of the development sleeve. The second magnetic pole is disposed on a downstream side of the first magnetic pole in the rotation direction of the development sleeve, and has the same polarity as the first magnetic pole, so as to attract the two-component developer to the developer carrying surface. The developing roller has a part from the first magnetic pole to the second magnetic pole on the downstream side in the rotation direction of the development sleeve, as a developer separating part for allowing the two-component developer to separate from the developer carrying surface. The developer separating part has a magnetic force reversal region, in which a resultant force of a vertical magnetic force and a horizontal magnetic force of the developer separating part increases as being apart from the developer carrying surface in the normal direction. Supposing that position P represents a position on the developer carrying surface, at which a ratio of the resultant force of the vertical magnetic force and the horizontal magnetic force of the developer separating part at 0.5 mm apart from the developer carrying surface in the normal direction, to the resultant force of the vertical magnetic force and the horizontal magnetic force of the developer separating part at 0.05 mm from the developer carrying surface in the normal direction, becomes maximum, and that position Q represents an intermediate position in the circumferential direction between a position Q1 on the developer carrying surface, at which the resultant force of the vertical magnetic force and the horizontal magnetic force of the developer separating part is 20 mT, on the first magnetic pole side of the developer separating part, and a position Q2 on the developer carrying surface, at which the resultant force of the vertical magnetic force and the horizontal magnetic force of the developer separating part is 20 mT, on the second magnetic pole side of the developer separating part, and that a distance in the circumferential direction on the developer carrying surface, from the position Q1 on the first magnetic pole side to the position Q2 on the second magnetic pole side of the magnetic force reversal region, is α (mm), and that a distance between the position Q1 and the position Q2 in the circumferential direction is β (mm), and that a distance between the position P and the position Q in the circumferential direction is γ (mm), and that γ has a positive value when the position Q is on the upstream side of the position P in the rotation direction of the development sleeve, and that γ has a negative value when the position Q is on the downstream side of the position P in the rotation direction of the development sleeve, then the following inequality (F1). When the inequality (F1) is satisfied, a variation width of a shear friction coefficient of the two-component developer is 0.02 or less, within a range where a surface coverage of the toner particles with respect to one carrier particle is 22.7% or more and 45.4% or less.

α−(18.9×(γ/β)²+20.8×(γ/β))>6 (F1)

A developing device according to a second aspect of the present disclosure includes a developing roller having a developer carrying surface for carrying a two-component developer containing toner particles and carrier particles, and supplies the toner particles in the two-component developer carried on the developer carrying surface to an electrostatic latent image, at a development position, so as to develop the electrostatic latent image. The developing roller includes a shaft, a magnet, and a development sleeve. The shaft extends in a predetermined direction. The magnet is fixed to an outer peripheral surface of the shaft, and has a plurality of magnetic poles in a circumferential direction of the shaft. The development sleeve is a cylindrical member in which the shaft is inserted, having an outer peripheral surface of the cylindrical member as the developer carrying surface, and is supported in a rotatable manner about the shaft. The magnet includes at least a first magnetic pole and a second magnetic pole as the magnetic poles. The first magnetic pole is disposed on a downstream side of the development position in a rotation direction of the development sleeve. The second magnetic pole is disposed on a downstream side of the first magnetic pole in the rotation direction of the development sleeve, and has the same polarity as the first magnetic pole, so as to attract the two-component developer to the developer carrying surface. The developing roller has a part from the first magnetic pole to the second magnetic pole on the downstream side in the rotation direction of the development sleeve, as a developer separating part for allowing the two-component developer to separate from the developer carrying surface. The developer separating part has a magnetic force reversal region, in which a resultant force of a vertical magnetic force and a horizontal magnetic force of the developer separating part increases as being apart from the developer carrying surface in the normal direction. Supposing that position P represents a position on the developer carrying surface, at which a ratio of the resultant force of the vertical magnetic force and the horizontal magnetic force of the developer separating part at 0.5 mm apart from the developer carrying surface in the normal direction, to the resultant force of the vertical magnetic force and the horizontal magnetic force of the developer separating part at 0.05 mm from the developer carrying surface in the normal direction, becomes maximum, and that position Q represents an intermediate position in the circumferential direction between a position Q1 on the developer carrying surface, at which the resultant force of the vertical magnetic force and the horizontal magnetic force of the developer separating part is 20 mT, on the first magnetic pole side of the developer separating part, and a position Q2 on the developer carrying surface, at which the resultant force of the vertical magnetic force and the horizontal magnetic force of the developer separating part is 20 mT, on the second magnetic pole side of the developer separating part, and that a distance in the circumferential direction on the developer carrying surface, from the position Q1 on the first magnetic pole side to the position Q2 on the second magnetic pole side of the magnetic force reversal region, is α (mm), and that a distance between the position Q1 and the position Q2 in the circumferential direction is β (mm), and that a distance between the position P and the position Q in the circumferential direction is γ (mm), and that γ has a positive value when the position Q is on the upstream side of the position P in the rotation direction of the development sleeve, and that γ has a negative value when the position Q is on the downstream side of the position P in the rotation direction of the development sleeve, then the following inequality (F2). When the inequality (F2) is satisfied, the variation width of the shear friction coefficient of the two-component developer is 0.037 or less, within the range where the surface coverage of the toner particles with respect to one carrier particle is 22.7% or more and 45.4% or less.

α−(18.9×(γ/β)²+20.8×(γ/β))>7 (F2)

A developing device according to a third aspect of the present disclosure includes a developing roller having a developer carrying surface for carrying a two-component developer containing toner particles and carrier particles, and supplies the toner particles in the two-component developer carried on the developer carrying surface to an electrostatic latent image, at a development position, so as to develop the electrostatic latent image. The developing roller includes a shaft, a magnet, and a development sleeve. The shaft extends in a predetermined direction. The magnet is fixed to an outer peripheral surface of the shaft, and has a plurality of magnetic poles in a circumferential direction of the shaft. The development sleeve is a cylindrical member in which the shaft is inserted, having an outer peripheral surface of the cylindrical member as the developer carrying surface, and is supported in a rotatable manner about the shaft. The magnet includes at least a first magnetic pole and a second magnetic pole as the magnetic poles. The first magnetic pole is disposed on a downstream side of the development position in a rotation direction of the development sleeve. The second magnetic pole is disposed on a downstream side of the first magnetic pole in the rotation direction of the development sleeve, and has the same polarity as the first magnetic pole, so as to attract the two-component developer to the developer carrying surface. The developing roller has a part from the first magnetic pole to the second magnetic pole on the downstream side in the rotation direction of the development sleeve, as a developer separating part for allowing the two-component developer to separate from the developer carrying surface. The developer separating part has a magnetic force reversal region, in which a resultant force of a vertical magnetic force and a horizontal magnetic force of the developer separating part increases as being apart from the developer carrying surface in the normal direction. Supposing that position P represents a position on the developer carrying surface, at which a ratio of the resultant force of the vertical magnetic force and the horizontal magnetic force of the developer separating part at 0.5 mm apart from the developer carrying surface in the normal direction, to the resultant force of the vertical magnetic force and the horizontal magnetic force of the developer separating part at 0.05 mm from the developer carrying surface in the normal direction, becomes maximum, and that a value of the ratio at the position P is “A”, and that position Q represents an intermediate position in the circumferential direction between a position Q1 on the developer carrying surface, at which the resultant force of the vertical magnetic force and the horizontal magnetic force of the developer separating part is 20 mT, on the first magnetic pole side of the developer separating part, and a position Q2 on the developer carrying surface, at which the resultant force of the vertical magnetic force and the horizontal magnetic force of the developer separating part is 20 mT, on the second magnetic pole side of the developer separating part, and that a distance in the circumferential direction on the developer carrying surface, from the position Q1 on the first magnetic pole side to the position Q2 on the second magnetic pole side of the magnetic force reversal region, is α (mm), and that a distance between the position Q1 and the position Q2 in the circumferential direction is β (mm), and that a distance between the position P and the position Q in the circumferential direction is γ (mm), and that γ has a positive value when the position Q is on the upstream side of the position P in the rotation direction of the development sleeve, and that γ has a negative value when the position Q is on the downstream side of the position P in the rotation direction of the development sleeve, then the following inequality (F3) is satisfied. When the inequality (F3) is satisfied, the variation width of the shear friction coefficient of the two-component developer is 0.02 or less, within the range where the surface coverage of the toner particles with respect to one carrier particle is 22.7% or more and 45.4% or less.

A/α+0.8334×(γ/β)≤0.275 (F3)

An image forming apparatus according to a fifth aspect of the present disclosure includes the above developing device, and prints the image developed by the developing device onto a sheet.

### BRIEF DESCRIPTION OF THE DRAWINGS

FIG. 1 is a schematic diagram of an image forming apparatus according to an embodiment.

FIG. 2 is a schematic diagram of a developing device and its vicinity according to the embodiment.

FIG. 3 is a schematic diagram of a developing device and its vicinity (including a replenishment unit) according to the embodiment.

FIG. 4 is a schematic diagram of a developer that is used for development by the developing device according to the embodiment.

FIG. 5 is a schematic diagram illustrating a state in a case where a toner surface coverage of the developer illustrated in FIG. 4 is less than 20%.

FIG. 6 is a schematic diagram illustrating a state in a case where the toner surface coverage of the developer illustrated in FIG. 4 is 20% to 45%.

FIG. 7 is a schematic diagram illustrating a state in a case where the toner surface coverage of the developer illustrated in FIG. 4 is more than 45%.

FIG. 8 is a graph showing a relationship between a shear friction coefficient and the toner surface coverage of the developer that is used for development by the developing device according to the embodiment.

FIG. 9 is a graph illustrating a magnetic force distribution of a developing roller of the developing device according to the embodiment.

FIG. 10 is a graph illustrating the magnetic force distribution (including a resultant force ratio) of a developing roller of the developing device according to the embodiment.

FIG. 11 is a schematic diagram of an image printed in an experiment for checking an effect of the present disclosure.

FIG. 12 is a graph illustrating an experiment result performed for checking the effect of the present disclosure.

FIG. 13 is a graph illustrating an experiment result performed for checking the effect of the present disclosure.

### DETAILED DESCRIPTION

### 1. Image Forming Apparatus

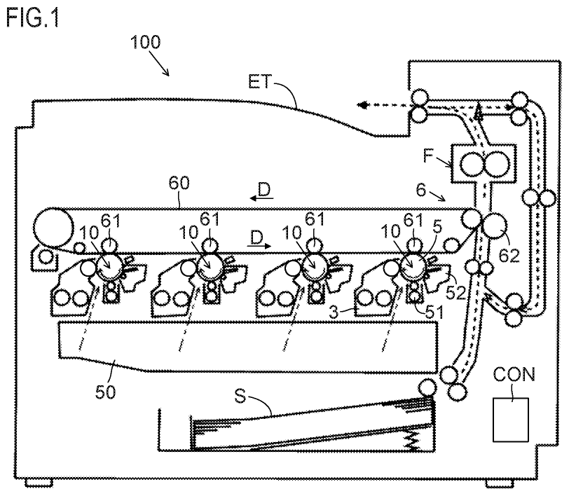

Hereinafter, with reference to FIG. 1, an image forming apparatus 100 of this embodiment is described. The image forming apparatus 100 is a printer.

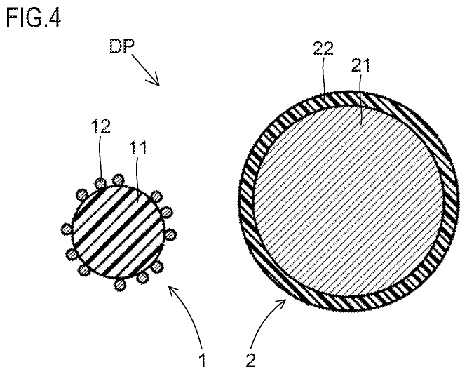

The image forming apparatus 100 uses a developer DP (see FIG. 4) so as to perform electrophotographic printing on a sheet S as a recording medium. Note that the developer DP is a two-component developer, and it contains toner (an aggregate of toner particles 1) and carrier (an aggregate of carrier particles 2).

The image forming apparatus 100 has a conveying path. In FIG. 1, the conveying path is shown by a broken line arrow. The image forming apparatus 100 supplies the sheet S stored in a cassette to the conveying path, and conveys the sheet S along the conveying path. In this way, the sheet S passes through a transfer position and a fixing position in this order, and then it is discharged onto a discharge tray ET. At the transfer position, a transferring process is performed on the sheet S. At the fixing position, a fixing process is performed on the sheet S.

The image forming apparatus 100 includes four image forming units 10 corresponding to four colors, i.e., cyan, magenta, yellow, and black colors. Each of the image forming units 10 forms an image using toner of the corresponding color. Hereinafter, one of the image forming units 10 is noted and a structure thereof is described. The image forming units 10 have the same basic structure. Therefore, descriptions of structures of other image forming units 10 are omitted by citing the following description.

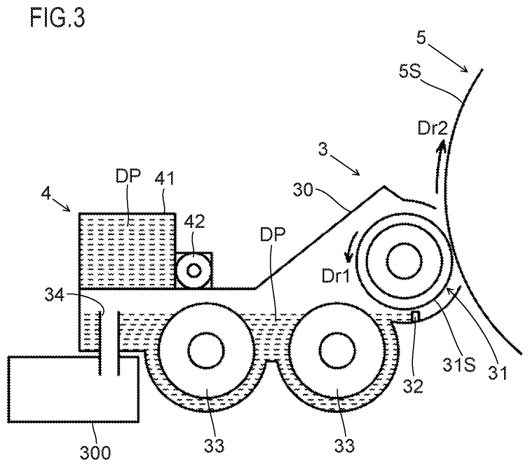

The image forming unit 10 includes developing device 3. The developing device 3 is connected to a replenishment unit 4 (see FIG. 3). In addition, the image forming unit 10 includes photosensitive drum 5.

The photosensitive drum 5 has an outer peripheral surface 5S that functions as a toner carrying surface (which is not denoted by a numeral in FIG. 1). An electrostatic latent image is formed on the outer peripheral surface 5S of the photosensitive drum 5, and the toner is supplied to the electrostatic latent image. The photosensitive drum 5 carries the supplied toner on the outer peripheral surface 5S. In the following description, the outer peripheral surface 5S of the photosensitive drum 5 is referred to as the drum outer peripheral surface 5S.

The image forming unit 10 further includes a charging device 51 and a cleaning device 52. The photosensitive drum 5 constitutes one unit together with the charging device 51 and the cleaning device 52. Note that the image forming unit 10 includes an exposure device 50. The single exposure device 50 is shared by the image forming units 10.

When the image forming unit 10 forms an image, the photosensitive drum 5 rotates. The charging device 51 is applied with a charging voltage from a not-shown charging voltage power supply. The charging device 51 charges the photosensitive drum 5. In this way, the drum outer peripheral surface 5S is charged at a predetermined potential. The exposure device 50 exposes the drum outer peripheral surface 5S, so as to form an electrostatic latent image on the drum outer peripheral surface 5S. The developing device 3 supplies the toner to the electrostatic latent image on the drum outer peripheral surface 5S, so as to develop the electrostatic latent image into a toner image. The cleaning device 52 removes residual toner on the drum outer peripheral surface 5S.

The image forming apparatus 100 includes a transfer unit 6. The transfer unit 6 transfers the toner image on the drum outer peripheral surface 5S of each photosensitive drum 5 to the sheet S. In other words, the transfer unit 6 transfers the images developed by the developing devices 3 to the sheet S.

The transfer unit 6 includes an intermediate transfer belt 60. The intermediate transfer belt 60 is an endless belt. The intermediate transfer belt 60 contacts the drum outer peripheral surface 5S of each photosensitive drum 5, and in this state, moves (rotates) in the direction shown by an arrow D.

The transfer unit 6 includes primary transfer rollers 61. There are a plurality of the primary transfer rollers 61, which are allotted to the cyan, magenta, yellow, and black colors, respectively. The primary transfer rollers 61 are disposed on an inner peripheral side of the intermediate transfer belt 60. Each of the primary transfer rollers 61 is disposed to face the drum outer peripheral surface 5S of the photosensitive drum 5 carrying the toner image of the corresponding color, via the intermediate transfer belt 60 between them.

In addition, the image forming apparatus 100 includes one secondary transfer roller 62. The secondary transfer roller 62 is pressed to contact the outer peripheral surface of the intermediate transfer belt 60 at the transfer position. A transfer nip is formed between the secondary transfer roller 62 and the intermediate transfer belt 60. In other words, the transfer nip is formed at the transfer position.

In a print job, the sheet S is conveyed to the transfer position (i.e., the transfer nip). The sheet S that is being conveyed passes through the transfer nip.

The intermediate transfer belt 60 receives primary transfer of toner images from the photosensitive drums 5. The intermediate transfer belt 60 rotates while carrying the toner images on the outer peripheral surface. When the sheet S is passing through the transfer nip, the sheet S contacts the outer peripheral surface of the intermediate transfer belt 60. In this way, the toner images are secondarily transferred to the sheet S that is passing through the transfer nip.

The image forming apparatus 100 includes a fixing unit F. The fixing unit F includes a heating roller and a pressure roller. The heating roller includes a heater inside. The pressure roller is pressed to contact the heating roller. The heating roller and the pressure roller contact each other with pressure so as to form a fixing nip at the fixing position.

In the print job, the sheet S after the transferring process passes through the fixing nip. In other words, the sheet S is sandwiched between the heating roller and the pressure roller at the fixing nip. The fixing unit F heats the sheet S that is passing through the fixing nip. At the fixing nip, the sheet S is pressed. The fixing unit F heats and presses the sheet S after the transferring process, so as to fix the toner image to the sheet S. After the fixing process, the sheet S is discharged onto the discharge tray ET.

### 2. Developing Device

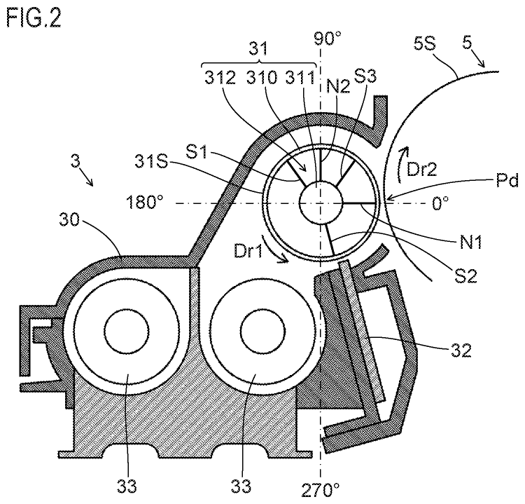

Hereinafter, with reference to FIG. 2 and FIG. 3, the developing device 3 of this embodiment is described. Note that FIG. 3 also illustrates the replenishment unit 4 connected to the developing device 3.

The developing device 3 uses the developer DP so as to develop the electrostatic latent image. A developing method of the developing device 3 is a trickle development method. The developing device 3 receives replenishment of the developer DP from the replenishment unit 4. In other words, the image forming apparatus 100 includes the replenishment units 4 in addition to the developing devices 3. The replenishment unit 4 may be one component of the developing device 3.

The developing device 3 includes a development casing 30. The developer DP is stored inside the development casing 30 in advance. The developing device 3 uses the developer DP stored in the development casing 30 so as to perform development. Here, the developer DP stored in the development casing 30 is referred to as “developer currently in use”. On the other hand, the developer DP replenished from the replenishment unit 4 into the development casing 30 is referred to as replenishment developer.

The developing device 3 includes a developing roller 31 as illustrated in FIG. 2. The developing roller 31 has its outer peripheral surface 31S as a developer carrying surface. In the following description, the outer peripheral surface 31S of the developing roller 31 is referred to as the developer carrying surface 31S.

The developing roller 31 is disposed inside the development casing 30 and is supported in a rotatable manner. The developer carrying surface 31S of the developing roller 31 is partially exposed from inside to outside of the development casing 30. Specifically, the development casing 30 has an opening at a position facing the drum outer peripheral surface 5S. From this opening, the developer carrying surface 31S is partially exposed to the outside. In this way, the developer carrying surface 31S and the drum outer peripheral surface 5S face each other. The developer carrying surface 31S faces the drum outer peripheral surface 5S at a development position Pd with a predetermined space between them. In other words, development position Pd is a position at which the developer carrying surface 31S and the drum outer peripheral surface 5S face each other with a predetermined space between them.

The developing roller 31 carries the developer currently in use on the developer carrying surface 31S, and supplies toner in the developer currently in use to the electrostatic latent image on the drum outer peripheral surface 5S, at the development position Pd. Note that, in this case, the developing roller 31 and the photosensitive drum 5 rotate individually. In the diagram, a rotation direction of the developing roller 31 is shown by an arrow Dr1, and a rotation direction of the photosensitive drum 5 is shown by an arrow Dr2.

The developing device 3 includes a regulating blade 32. The regulating blade 32 is attached to the development casing 30. The regulating blade 32 has a distal end part disposed close to the developer carrying surface 31S. The distal end part of the regulating blade 32 is disposed on an upstream side of the development position Pd in the rotation direction of the developing roller 31 (specifically, on an upstream side of a development sleeve 310 described later in the rotation direction).

The developing device 3 includes two stirring screws 33. Each of the stirring screws 33 is disposed inside the development casing 30 and is supported in a rotatable manner. Each of the stirring screws 33 has a structure in which a helical blade is disposed on a rotation shaft. Each of the stirring screws 33 rotates so as to stir and convey the developer currently in use, while the toner in the developer currently in use is charged.

During rotation of the developing roller 31, the carrier carrying the toner in the developer currently in use is attracted to the developer carrying surface 31S, by a magnetic force of the developing roller 31 (specifically, a magnetic force of a magnet 312 described later), and a magnetic brush containing the toner and the carrier is formed on the developer carrying surface 31S. When the magnetic brush passes through a gap formed between the developing roller 31 and the regulating blade 32 (hereinafter, referred to as a regulation gap), it is regulated to have a constant layer thickness. After that, the magnetic brush contacts the drum outer peripheral surface 5S. Note that when the developer currently in use (the magnetic brush) passes through the regulation gap, a stress is applied to the developer currently in use.

In addition, the developing roller 31 is supplied with a development voltage including a DC voltage from a not-shown development voltage power supply. The development voltage is a voltage in which an AC voltage is superimposed on the DC voltage. When the development voltage is applied to the developing roller 31, a potential difference is generated between the developing roller 31 and the photosensitive drum 5. This potential difference allows the toner in the magnetic brush to move from the developing roller 31 to the photosensitive drum 5. The photosensitive drum 5 carries the toner moved from the magnetic brush on the developer carrying surface 31S, on the drum outer peripheral surface 5S. The toner is supplied to the electrostatic latent image on the drum outer peripheral surface 5S (to parts whose potentials are decreased by exposure). In this way, the electrostatic latent image on the drum outer peripheral surface 5S is developed into the toner image.

The developing roller 31 includes the development sleeve 310. The development sleeve 310 is a cylindrical member having a central axis extending in a predetermined direction. A direction parallel to the rotation axis of the photosensitive drum 5 is the predetermined direction. The development sleeve 310 has its outer peripheral surface as the developer carrying surface 31S. The development sleeve 310 is supported in a rotatable manner about the central axis.

The developing roller 31 includes a shaft 311. The shaft 311 is a round bar extending in a predetermined direction. The shaft 311 has a D-cut surface on one side end in the axial direction, and the D-cut surface is held so as to be fixed and unable to rotate. The shaft 311 is inserted in the development sleeve 310. In other words, the development sleeve 310 is supported in a rotatable manner about the shaft 311. The development sleeve 310 rotates in the direction shown by the arrow Dr1.

Although not illustrated, each end of the development sleeve 310 is fixed to a flange. Each flange is supported by the shaft 311 in a rotatable manner. For instance, a bearing inner ring is fixed to the shaft 311, while an outer ring of the bearing is fixed to the flange. In addition, one of the flanges is linked to a motor. When the motor is driven, the development sleeve 310 rotates.

The developing roller 31 includes the magnet 312. The magnet 312 is fixed to an outer peripheral surface of the shaft 311, so as to be disposed inside the development sleeve 310. The magnet 312 has a plurality of magnetic poles in a circumferential direction of the shaft 311. Hereinafter, described are arrangement positions of the magnetic poles viewed from the axial direction of the development sleeve 310 (the predetermined direction).

A first magnetic pole S1 having a predetermined polarity is disposed on the downstream side of the development position Pd, in the rotation direction of the development sleeve 310. Specifically, the first magnetic pole S1 is disposed on the downstream side of the line connecting the rotation center of the development sleeve 310 and the development position Pd, in the rotation direction of the development sleeve 310.

A second magnetic pole S2 having the same polarity as the first magnetic pole S1 is disposed on the downstream side of the first magnetic pole S1, in the rotation direction of the development sleeve 310. The second magnetic pole S2 works as a catching pole that forms a magnetic field for pumping up the developer currently in use to the developer carrying surface 31S. This function of the second magnetic pole S2 allows the developer currently in use to be attracted to the developer carrying surface 31S and carried on the developer carrying surface 31S. In other words, the second magnetic pole S2 (the catching pole) supplies the developer currently in use to the developer carrying surface 31S and allows the developer carrying surface 31S to carry the developer currently in use.

For instance, as one embodiment, the second magnetic pole S2 also works as a regulation pole. In this case, the second magnetic pole S2 is disposed at a regulating position facing the regulating blade 32. The second magnetic pole S2 faces the regulating blade 32 via the development sleeve 310. Further, the second magnetic pole S2 forms a magnetic field for regulating a layer thickness of the developer currently in use on the developer carrying surface 31S, together with the regulating blade 32.

As another embodiment, the second magnetic pole S2 does not work as the regulation pole. In this case, although not shown, the second magnetic pole S2 (the catching pole) is disposed on the upstream side of the regulating position in the rotation direction of the development sleeve 310. The regulation pole is separately disposed at the regulating position.

A main pole N1 having a polarity different from that of the first magnetic pole S1 is disposed at the development position Pd. Specifically, the main pole N1 is disposed on the line connecting the rotation center of the development sleeve 310 and the development position Pd. An electric field is formed between the main pole N1 and the drum outer peripheral surface 5S. In this way, the toner is supplied from the developer carrying surface 31S to the drum outer peripheral surface 5S.

A conveying pole S3 having a polarity opposite to that of the main pole N1 is disposed on the downstream side of the main pole N1, in the rotation direction of the development sleeve 310, and on the further downstream side in the rotation direction of the development sleeve 310, a conveying pole N2 having the same polarity as the main pole N1 is disposed. Then, the developer currently in use that was not used for development is conveyed from the main pole N1 to the conveying pole S3 and to the conveying pole N2 sequentially on the developer carrying surface 31S.

Here, the developing roller 31 has a developer separating part. The developing roller 31 allows the developer currently in use, which is being conveyed on the developer carrying surface 31S, to separate and drop from the developer carrying surface 31S at the developer separating part. The developer currently in use that separates and drops from the developer carrying surface 31S is stirred and pumped up to the developer carrying surface 31S again.

The developer separating part is at least a part of the area from the first magnetic pole S1 to the second magnetic pole S2 on the downstream side in the rotation direction of the development sleeve 310. In the developer separating part, because the first magnetic pole S1 and the second magnetic pole S2 have the same polarity, the developer currently in use separates and drops from the developer carrying surface 31S. In other words, the developer separating part is constituted of the first magnetic pole S1 and the second magnetic pole S2.

In addition, as illustrated in FIG. 3, the developing device 3 includes the discharge path 34. The discharge path 34 connects the inside of the development casing 30 and a collection box 300. In this way, excessive developer currently in use flows into the discharge path 34, flows along the discharge path 34, and reaches the collection box 300. In other words, the collection box 300 stores the excessive developer currently in use.

The replenishment unit 4 includes a container 41 and a replenishment member 42. The container 41 stores replenishment developer. The replenishment member 42 replenishes the replenishment developer stored in the container 41 to the developing device 3. For instance, the replenishment member 42 includes a screw shaft. When the screw shaft rotates, the replenishment developer is replenished from the container 41 to the inside of the development casing 30.

Note that the image forming apparatus 100 includes a controller unit CON (see FIG. 1). The developing device 3 is equipped with a T/C sensor. The T/C sensor is connected to the controller unit CON. The T/C sensor detects a mixing ratio between the toner and the carrier in the developer currently in use. On the basis of an output of the T/C sensor, the controller unit CON controls replenishment of the replenishment developer from the replenishment unit 4 to the developing device 3. In other words, the controller unit CON controls the replenishment member 42 (to rotate and stop the screw shaft).

The T/C sensor is a magnetic permeability sensor and outputs a value corresponding to a magnetic permeability of the developer currently in use. As the ratio of the carrier in the developer currently in use is higher, the magnetic permeability of the developer currently in use is higher. Utilizing this fact, the mixing ratio between the toner and the carrier in the developer currently in use is detected. Further, a toner remaining amount in the developer currently in use can be detected from the detected mixing ratio.

When starting to use the developing device 3, the development casing 30 already stores initial developer inside. The initial developer is the developer DP stored inside the development casing 30 when the image forming apparatus 100 is shipped (before a user uses the image forming apparatus 100). In other words, when starting to use the developing device 3, the developer currently in use contains only the initial developer.

After starting use of the developing device 3, when the print job is performed, the developer currently in use is consumed and decreased. In other words, the initial developer is decreased inside the development casing 30. For this reason, after starting use of the developing device 3, the replenishment developer is replenished from the replenishment unit 4 to the developing device 3. The developer DP stored in the container 41 is the replenishment developer.

While the image forming apparatus 100 continues the print job, the replenishment developer is replenished into the development casing 30 while the developer currently in use is discharged from the inside of the development casing 30. In this way, inside the development casing 30, the developer currently in use is gradually changed, i.e., the initial developer is gradually replaced by the replenishment developer. In other words, the initial developer and the replenishment developer are mixed as the developer currently in use.

### 3. Developer

Hereinafter, with reference to FIG. 4, the developer DP of this embodiment is described. The developer DP is a two-component developer.

The toner of the developer DP contains toner particles 1, and the carrier of the developer DP contains carrier particles 2. The toner is an aggregate of the toner particles 1, and the carrier is an aggregate of the carrier particles 2. FIG. 4 schematically illustrates the single toner particle 1 and the single carrier particle 2.

Note that the developer DP as the initial developer and the developer DP as the replenishment developer may have the same components, mixing ratio between the toner and the carrier, production method, and the like. Alternatively, at least a part of the components, the mixing ratio between the toner and the carrier, the production method, and the like may be different between the developer DP as the initial developer and the developer DP as the replenishment developer.

### <3-1. Toner>

The toner particle 1 has a toner mother particle 11. The toner mother particle 11 is, for example, a non-encapsulated toner mother particle without a shell layer. The toner mother particle 11 may be an encapsulated toner mother particle in which a toner core is coated with a shell layer.

The toner mother particle 11 contains binder resin, for example. As the binder resin, a thermoplastic resin such as polyester resin may be used. The toner mother particle 11 may contain a coloring agent, a charge control agent, a mold release agent, and the like.

The toner particle 1 has external additive particles 12. The external additive particles 12 adhere to the surface of the toner mother particle 11. As the external additive particles 12, silica particles, aluminum oxide particles, or the like may be used. In addition, if necessary, resin particles, magnesium oxide particles, zinc oxide particles, or the like may be used as the external additive particles 12.

In the toner particle 1, the contained amount of the silica particles is preferably 0.1 pts. mass or more and 10.0 pts. mass or less, and more preferably 0.4 pts. mass or more and 3.0 pts. mass or less, with respect to 100.0 pts. mass of toner mother particle 11. In addition, the mean primary particle diameter of the silica particle is preferably 10 nm or more and 30 nm or less, and more preferably 15 nm or more and 25 nm or less. The silica particle may be surface treated.

The contained amount of the aluminum oxide particles in the toner particle 1 is preferably 0.05 pts. mass or more and 3.0 pts. mass or less, and more preferably 0.3 pts. mass or more and 1.5 pts. mass or less, with respect to 100.0 pts. mass of toner mother particle 11. In addition, the mean primary particle diameter of the aluminum oxide particle is preferably 200 nm or more and 600 nm or less, and more preferably 300 nm or more and 500 nm or less.

Note that the mean primary particle diameter in this specification is a mean value of equivalent circle diameters of primary particles measured using a scanning electron microscope (a Heywood diameter: a diameter of a circle having the same area as a projected area of the primary particle). The mean primary particle diameter is, for example, a mean value of equivalent circle diameters of 100 primary particles. For measuring the mean primary particle diameter, a field emission type scanning electron microscope (“JSM-7600F” manufactured by Japan Electron Optics Laboratory Co., Ltd.) can be used.

### <3-2. Carder>

The carrier particle 2 has a carrier core 21. The carrier core 21 contains magnetic material. The carrier core 21 may contain only one type of magnetic material, or may contain two or more types of magnetic materials. As the magnetic material, it is possible to use a metal oxide such as ferrite, magnetite, or maghemite. Note that the ferrite has high flowability and chemical stability tendency. Therefore, it is preferred that the carrier core 21 contain ferrite. As an example of the ferrite, there is Ba ferrite, Mn ferrite, Mn—Zn ferrite, Ni—Zn ferrite, Mn—Mg ferrite, Ca—Mg ferrite, Li ferrite, and Cu—Zn ferrite. The shape of the carrier core 21 is not particularly limited, and it may be an irregular shape or a spherical shape.

An average particle size of the carrier cores 21 is 20 μm or more and 60 μm or less. If the average particle size of the carrier cores 21 is less than 20 μm, carrier development tends to occur in which the carrier adheres to the photosensitive drum 5. If the carrier development occurs, the carrier moves from the photosensitive drum 5 to the intermediate transfer belt 60, which causes transfer voids. Further, when the carrier is moved to a cleaning member of the intermediate transfer belt 60, insufficient cleaning may occur. On the other hand, if the average particle size of the carrier cores 21 is more than 60 μm, the magnetic brush on the developing roller 31 becomes rough, and image quality is deteriorated. For this reason, it is preferred that the average particle size of the carrier cores 21 be 20 μm or more and 60 μm or less.

A saturation magnetization of the carrier core 21 is 65 emu/g or more and 90 emu/g or less. If the saturation magnetization of the carrier core 21 is low, the carrier development occurs, and image quality is deteriorated. On the other hand, it is difficult to produce carrier cores having a relatively high saturation magnetization. For this reason, it is preferred that the saturation magnetization of the carrier core 21 be 65 emu/g or more and 90 emu/g or less. If the carrier core 21 contains Mn ferrite, as the Mn content is higher, the saturation magnetization of the carrier core 21 tends to be lower. If the carrier core 21 contains Mn—Mg ferrite, as the Mg content is higher, the saturation magnetization of the carrier core 21 tends to be lower. Note that in this specification, the saturation magnetization is a value measured using a sensitive vibrating sample magnetometer (“VSM-P7” manufactured by Toei Industry Co., Ltd.) under the condition of an external magnetic field of 3,000 (Oe).

The carrier particle 2 has a coat layer 22. The coat layer 22 coats the surface of the carrier core 21. For instance, the entire surface of the carrier core 21 is coated with the coat layer 22. The coat layer 22 contains coat resin.

The coat resin may contain silicone resin. For instance, silicone resin may be a principal component of the coat resin (a principal component of the coat resin in mass base may be silicone resin). As a preferred example of the silicone resin, there is silicone resin having a methyl group, and epoxy modified silicone resin. An example of the silicone resin having a methyl group is a silicone resin that has a methyl group but does not have a phenyl group. Another example of the silicone resin having a methyl group is a silicone resin that has a methyl group and a phenyl group.

In addition, the coat resin may contain fluorocarbon resin. For instance, the coat resin may contain fluorocarbon resin and polyimide resin.

The coat layer 22 contains barium titanate particles. However, the coat layer 22 may not necessarily contain the barium titanate particles. For instance, the coat layer 22 made of silicone resin contains the barium titanate particles. The coat layer 22 made of fluorocarbon resin and polyimide resin does not contain the barium titanate particles.

The barium titanate particles have different characteristics depending on a production method. For instance, barium titanate particles produced by a hydrothermal synthesis method have voids inside, and hence have a small true specific gravity, and also the particle diameter distribution thereof is sharp. For this reason, the barium titanate particles produced by the hydrothermal synthesis method have better dispersibility in the coat resin than barium titanate particles produced by other method, and uniform dispersion can be achieved. Therefore, the barium titanate particles produced by the hydrothermal synthesis method is suitable for use because chargeability of the carrier is also uniformed.

The mean primary particle diameter of the barium titanate particles is preferably 100 nm or more and 500 nm or less. If the mean primary particle diameter of the barium titanate particles is less than 100 nm, a relative dielectric constant of the barium titanate particle is rapidly decreased, and hence the effect of the relative dielectric constant is decreased. On the other hand, if the mean primary particle diameter of the barium titanate particles is more than 500 nm, uniform dispersion is difficult. Therefore, the coat layer 22 contains the barium titanate particles having a mean primary particle diameter of 102 nm.

A contained amount of the barium titanate particle is preferably 5 pts. mass or more and 45 pts. mass or less with respect to 100 pts. mass of the coat resin. If the contained amount of the barium titanate particles is less than 5 pts. mass, a ferroelectric effect is deteriorated. On the other hand, if the contained amount of the barium titanate particles is more than 45 pts. mass, the barium titanate particles cannot be contained in the coat resin, and hence the barium titanate particles are released from the coat resin. Therefore, the coat layer 22 contains 10 pts. mass of the barium titanate particles with respect to 100 pts. mass of the coat resin.

The coat layer 22 contains carbon black particles. Because the carbon black particles are electric conductive, when the coat layer 22 contains the carbon black particles, charges move smoothly from the carrier particles 2 to the toner particle 1. As a result, the toner particles 1 can be charged to a desired charge amount. In this way, an image having little fogging can be formed. In addition, even if the toner concentration in the developer DP changes, a change in the toner charge amount can be small, and an image having a desired density can be stably formed.

The contained amount of the carbon black particles is preferably 2 pts. mass or more and 6 pts. mass or less with respect to 100 pts. mass of the coat resin. It is because if the contained amount of the carbon black particles is less than 2 pts. mass, the resistance is increased, and the charge cannot move sufficiently. On the other hand, if the contained amount of the carbon black particles is more than 6 pts. mass, the resistance is decreased, and leakage tend to occur.

Because the coat layer 22 contains a ferroelectric material (the barium titanate particles) and a conductive material (the carbon black particles), the following effect can be obtained.

A ferroelectric material has high charge retention capability, and can provide sufficient charge to the toner particles 1. The conductive material can allow the charge to move smoothly from the carrier particles 2 to the toner particles 1. By synergy of these two effects, even if the toner concentration in the developer DP (corresponding to a toner surface coverage described later) is increased, so that the number of toner particles 1 to be charged is increased, the charge can be provided up to a saturation charge amount level of the toner particles 1.

Note that, because the charge cannot usually be provided up to a saturation charge amount level of the toner particles 1, the charge amount is decreased along with an increase of the toner concentration in the developer DP. However, by using a dielectric material and a conductive material together, charge providing ability is improved, and the charge amount is hardly decreased even if the toner concentration in the developer DP increases. For this reason, it is preferred to constitute the coat layer 22 using the coat resin in which the ferroelectric material (the barium titanate particles) and the conductive material (the carbon black particles) are added.

### <4. Shear Friction Coefficient of Developer>

### <4-1. Definition of Shear Friction Coefficient>

The shear friction coefficient of the developer is determined on the basis of a measurement result using a powder bed shear stress measurement device (“NS-S500” manufactured by Nano Seeds Corporation). This measurement is performed in accordance with JISZ8835:2016. A powder layer of the developer is a measuring object.

The powder bed shear stress measurement device is equipped with a shear cell constituted of an upper fixed cell and a lower movable cell. The upper fixed cell has a cylindrical shape. The lower movable cell has a recess indented from the top surface downward. The upper fixed cell is disposed on the top surface of the lower movable cell. The lower movable cell can move laterally with respect to the upper fixed cell. When filling the measuring object into the shear cell, the recess space of the lower movable cell is aligned to the inner space of the cylinder as the upper fixed cell in the up and down direction. Then, the sample is filled into the inner space of the cylinder of the upper fixed cell (including the recess space of the lower movable cell). Note that the sample may be the developer including the toner and carrier, or may be only the carrier.

When measuring the shear friction coefficient of the developer (or the carrier), the sample is filled into the shear cell, and the top surface of the powder layer is flattened. After that, while moving the lower movable cell horizontally, a downward indentation load on the powder layer is changed in five steps (5N, ION, 15N, 20N, and 25N) so as to measure a normal stress and a shear stress along time, and the five points are plotted on a graph, in which the vertical axis represents the shear stress while the horizontal axis represents the normal stress. Then, the approximate straight line of the five points is drawn on the graph, and a value of a gradient tan 0 of the straight line is determined as the shear friction coefficient of the developer (or the carrier). Measurement conditions of the shear friction coefficient of the developer (or the carrier) are shown as follows.
sample amount: 15 g
sampling frequency: 10 Hz
device configuration identification symbol: BF82XB
upper fixed cell inner diameter: 30 mm
lower movable cell depth: 5 mm
shear speed: 10 m/sec
shear band thickness: 0.2 mm
compression speed: 0.2 mm/sec

### <4-2. Adhesion of Toner Particles to Carrier Particle>

Adhesion of the toner particles 1 to the carrier particle 2 causes a difference of behavior of the toner particles 1. This difference affects the shear friction coefficient of the developer DP.

If the adhesion of the toner particles 1 to the carrier particle 2 is relatively weak, the toner particles 1 can move on the carrier particle 2. In this case, the toner particles 1 work like lubricant. For this reason, as a surface coverage of the toner particles with respect to one carrier particle (hereinafter, simply referred to as a toner surface coverage) is higher, the shear friction coefficient of the developer DP is smaller.

If the adhesion of the toner particles 1 to the carrier particle 2 is strong, the toner particles 1 are fixed to the carrier particle 2. In this case, the toner particles 1 allows the carrier particle 2 to have an irregular shape. For this reason, as the toner surface coverage is higher, the shear friction coefficient of the developer DP is larger.

<4-3. Toner Particle Coverage with Respect to Carrier Particle>

As the number of the toner particles 1 existing on the surface of the carrier particle 2 and its vicinity is larger, the toner surface coverage is higher, while the number of the toner particles 1 existing on the surface of the carrier particle 2 and its vicinity is smaller, the toner surface coverage is lower. In other words, the toner surface coverage of the developer DP corresponds to the toner concentration. The toner surface coverage of the developer DP affects the shear friction coefficient of the developer DP.

When a volume average particle diameter of the toner particle 1 is r, a volume average particle diameter of the carrier particle 2 is R, and the number of toner particles 1 with respect to one carrier particle 2 is n, then the toner surface coverage of the developer DP is calculated by the following equation.

toner surface coverage (%)=(nr²)/(4R²)×100

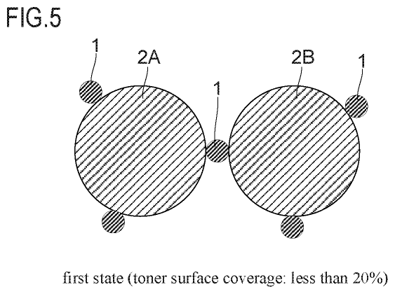

A state of the developer DP can be classified into three, i.e., a first state, a second state, and a third state, in accordance with a difference of the toner surface coverage. The first to the third states are schematically illustrated in FIGS. 5 to 7, respectively. In this description, for convenience's sake, in order to discriminate between one and the other of the neighboring carrier particles 2, each carrier particle 2 is denoted by suffix A or B. In addition, in FIG. 5 to FIG. 7, for convenience's sake, only some of the toner particles are denoted by 1.

The state illustrated in FIG. 5 is the first state, in which the toner surface coverage is less than 20%. In the first state, there is a region where the toner particle 1 on one carrier particle 2A contacts the other carrier particle 2B directly.

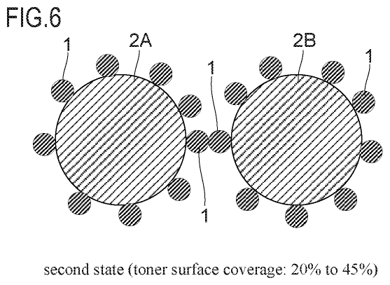

The state illustrated in FIG. 6 is the second state, in which the toner surface coverage is 20% or more and 45% or less. In the second state, there is always a region where the toner particle 1 on one carrier particle 2A contacts the toner particle 1 on the other carrier particle 2B.

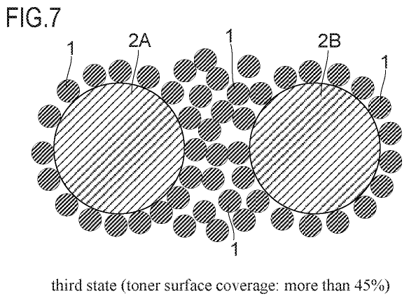

The state illustrated in FIG. 7 is the third state, in which the toner surface coverage is more than 45%. In the third state, there is the toner particle 1 that is not held on the carrier particle 2 but is floating.

Note that, according to the calculation, when the particles are arranged in square, the toner surface coverage is 78.5%. However, in fact, because the toner particles 1 are charged at the same polarity, they are repelled by each other, and the toner surface coverage does not reach 78.5% but has a limitation of approximately 50%. In other words, in actual use, it becomes the second state (see FIG. 6).

### <4-4. Coat Resin of Carrier Particle>

The adhesion of the toner particle 1 to the carrier particle 2 is different between the developer DP using silicone resin as the coat resin (hereinafter, may be referred to as a silicone coated developer), and the developer DP using fluorocarbon resin as the coat resin (hereinafter, may be referred to as a fluorine coated developer).

The silicone coated developer has a weaker adhesion of the toner particle 1 to the carrier particle 2 than the fluorine coated developer. For this reason, in the first state (see FIG. 5), the toner particles 1 work as a lubricant, and the shear friction coefficient decreases along with an increase in the toner surface coverage (the toner concentration). In the second state (see FIG. 6), the number of the toner particles 1 working as a lubricant increases, but after it increases to some extent, the shear friction coefficient does not change so much. In other words, in the silicone coated developer, a variation width of the shear friction coefficient in the second state (in the real use state) is small.

In the fluorine coated developer, the adhesion of the toner particle 1 to the carrier particle 2 is stronger than in the silicone coated developer. For this reason, in the first state (see FIG. 5), the toner particles 1 are fixed to the carrier particle 2, and the shear friction coefficient increases along with an increase in the toner surface coverage (the toner concentration). In the second state (see FIG. 6), the number of the toner particles 1 fixed to the carrier particle 2 is increased. In this way, along with an increase in the toner surface coverage (the toner concentration), the shear friction coefficient increases. In other words, in the fluorine coated developer, the shear friction coefficient in the second state (in the real use state) also has a larger variation width than the silicone coated developer.

Note that in the third state (see FIG. 7), a sufficient number of the toner particles 1 adhere to the carrier particle 2, and hence floating toner particles 1 occur. The floating toner particles 1 work as a lubricant. In this way, if the toner surface coverage is more than 45%, regardless of whether the coat resin of the carrier particle 2 is silicone resin or fluorocarbon resin, the shear friction coefficient is decreased along with an increase in the toner surface coverage (the toner concentration).

### 5. Variation Width of Shear Friction Coefficient

In order to check the variation width of the shear friction coefficient in the second state (in the real use state) for each of the silicone coated developer and the fluorine coated developer, the developer was prepared by the following method, and the shear friction coefficient was measured.

### <5-1. Preparation of Toner>

The toner of the developer to be a measuring object was prepared by the following method.

### <5-1-1. Synthesis of Amorphous Polyester Resin>

A reaction container, equipped with a thermometer (thermocouple), a dewatering conduit, a nitrogen gas introduction conduit, and a stirring device (stirring blade), was set in an oil bath. Then, 1,575 g of bisphenol A propylene oxide additive (BPA-PO), 163 g of bisphenol A ethylene oxide additive (BPA-EO), 377 g of fumaric acid, and 4 g of catalyst (dibutyltin oxide) were put into the reaction container.

After creating a nitrogen atmosphere in the reaction container, the temperature inside the reaction container was raised to 220 degrees Celsius while stirring the contents. Under the conditions of the nitrogen atmosphere and the temperature of 220 degrees Celsius, polymerization reaction of the contents in the reaction container was performed for 8 hours while removing by-product water. Next, the pressure inside the reaction container is reduced, and under the conditions of the reduced pressure atmosphere (pressure: 7,999 Pa) and the temperature of 220 degrees Celsius, the polymerization reaction of the contents in the reaction container was performed for more and 1 hour. In addition, the temperature inside the reaction container was reduced to 210 degrees Celsius, and then 336 g of trimellitic anhydride was added into the reaction container. Then, under the conditions of the reduced pressure atmosphere (pressure: 7,999 Pa) and the temperature of 210 degrees Celsius, reaction of the contents in the reaction container was performed. After that, the reaction product was taken out from the reaction container and was cooled, and hence the amorphous polyester resin having the following physical properties was obtained. Note that the polyester resin obtained in this way did not clearly show its endothermic peak in the endothermic curve measured using a differential scanning calorimeter, and its clear melting point was not able to be measured, and thus it was determined to be amorphous.
softening point (Tm): 100 degrees Celsius
glass transition point (Tg): 50 degrees Celsius
mass average molecular weight (Mw): 30,000
acid value: 15 mgKOH/g
hydroxyl value: 30 mgKOH/g

### <5-1-2. Preparation of Toner Mother Particles>

Using an FM mixer (“FM-10B” manufactured by Nippon Coke & Engineering Co., Ltd.), 100 pts. mass of binder resin, 4 pts. mass of coloring agent, 1 pts. mass of charge control agent, and 5 pts. mass of mold release agent were mixed, so that the mixture was obtained. As the binder resin, the amorphous polyester resin described above was used. As the coloring agent, copper phthalocyanine blue pigment (C.I. Pigment Blue 15:3) was used. As the charge control agent, quaternary ammonium salt (“BONTRON (registered trademark) P-51” manufactured by Orient Chemical Industries Co., Ltd.) was used. As the mold release agent, carnauba wax (“Special Carnauba Wax 1st” manufactured by S. KATO & CO.) was used.

Next, using a twin-screw extruder (“PCM-30 type” manufactured by Ikegai Co., Ltd.), the mixture was melted and kneaded, so that the melted and kneaded material was obtained. In addition, using a mechanical pulverizer (“Turbo Mill” manufactured by Freund-Turbo Corporation), the melted and kneaded material was pulverized, so that the pulverized material was obtained. Then, using a classifier (“Elbow Jet” manufactured by Nittetsu Mining Co., Ltd.), the pulverized material was classified. In this way, powder-like toner mother particles having a volume median diameter of 6.8 m and a true specific gravity of 1.2 g/cm³ were obtained. Note that the volume median diameter (Dso) is a median diameter measured using a laser diffraction/scattering type particle size distribution measurement device (“LA-950” manufactured by HORIBA, Ltd.).

### <5-1-3. External Addition to Toner Mother Particles>

Using the FM mixer (“FM-10B” manufactured by Nippon Coke & Engineering Co., Ltd.), 100.0 pts. mass of the toner mother particle described above, 1.0 pts. mass of the silica particles (mean primary particle diameter: 20 nm), and 0.75 pts. mass of aluminum oxide particles (“AEROXIDE (registered trademark) Alu C805” manufactured by Nippon Aerosil Co., Ltd., BET specific surface area: 75 to 105 m²/g) were mixed for 5 minutes under the condition of 4,000 rpm, so that the mixture was obtained. Note that the mean primary particle diameter of the aluminum oxide particles is more than 300 nm. Then, using a sieve of 200 mesh (aperture of 75 m), the mixture was sieved, and the toner shown in Table 1 was obtained. In the following description, the toner is shown by “T”.

TABLE 1
toner (T)

| mother | external additive particle | |
|---|---|---|
| particle | alumina particle | silica particle |

| pts. mass | pts. mass | pts. mass | diameter (nm) |
|---|---|---|---|
| 100 | 0.75 | 1 | 20 |

### <5-2. Preparation of Carrier>

The carrier of the developer to be a measuring object was prepared by the following method.

### <5-2-1. Preparation of Coating Liquid>

Coat resin solution, at least one of the barium titanate particles and the carbon black particles, and toluene were put into a stainless steel container. Then, using a homogenizer, the contents in the stainless steel container were mixed, so that the coating liquid was obtained. As the barium titanate particles, “BT-01” manufactured by Sakai Chemical Industry Co., Ltd. (mean primary particle diameter: 304 nm) was used. As the carbon black particle, “Ketjenblack (registered trademark) EC300J” manufactured by LION SPECIALTY CHEMICALS CO., Ltd. (mean primary particle diameter: 39.5 nm), which is conductive carbon black, was used.

### <5-2-2. Preparation of Carrier Particles>

Using a fluid bed coating machine (“FD-MP-01 D type” manufactured by Powrex Corporation), 5,000 g of the carrier cores were allowed to flow, while the coating liquid was sprayed to the carrier cores. In this way, the carrier cores coated with the coating liquid were obtained. In this case, as the carrier cores, manganese ferrite cores (manufactured by DOWA IP Creation Co., Ltd.) were used. Next, using an electric furnace, the carrier cores coated with the coating liquid were fired at 200 degrees Celsius for 1 hour, so that the coat layer was formed on the surface of the carrier core. In this way, the carrier particles were obtained.

Here, in this measurement, carriers C1 to C3, i.e., three types of carriers were used. In other words, three types of developers were used. Characteristics of the carriers C1 to C3 are shown in Table 2. Note that each toner of the developers is the toner T described above. In addition, the toner surface coverage of each developer (i.e., toner concentration) is 22.7% or more and 45.4% or less.

carrier

| | particle | saturation | | | | shear friction |
|---|---|---|---|---|---|---|
| | diameter | magnetization | | coat resin | | coefficient |
| type | (μm) | (emu/g) | coat resin | internal additive | | variation width |
| C1 | 40 | 80 | silicone | CB(4 pts. mass) | BT(10 pts. mass) | 0.009 |
| C2 | 36 | 70 | silicone | CB(3 pts. mass) | BT(10 pts. mass) | 0.020 |
| C3 | 36 | 70 | PI + FEP | CB(2 pts. mass) | | 0.037 |

As illustrated in Table 2, in the carriers C1 and C2, the coat layer was formed using the coat resin containing silicone resin. As the silicone resin, “KR-255” manufactured by Shin-Etsu Chemical Co., Ltd. (solid content: methylphenyl silicone resin, solid content concentration: 50 mass %) was used. On the other hand, in the carrier C3, the coat layer was formed using the coat resin containing polyimide resin (PI) and fluorocarbon resin (FEP).

A contained amount of the carbon black particles (CB) in the coat layer of the carrier C1 is 4 pts. mass with respect to 100 pts. mass of the coat resin, and a contained amount of the barium titanate particles (BT) in the coat layer of the carrier C1 is 10 pts. mass with respect to 100 pts. mass of the coat resin. A contained amount of the carbon black particles (CB) in the coat layer of the carrier C2 is 3 pts. mass with respect to 100 pts. mass of the coat resin, and a contained amount of the barium titanate particles (BT) in the coat layer of the carrier C2 is 10 pts. mass with respect to 100 pts. mass of the coat resin. A contained amount of the carbon black particles (CB) in the coat layer of the carrier C3 is 2 pts. mass with respect to 100 pts. mass of the coat resin. Note that the coat layer of the carrier C3 does not contain barium titanate particles.

A volume average particle diameter of the carrier core of the carrier C1 is 40 m, a saturation magnetization of the carrier core of the carrier C1 is 80 emu/g, and a true specific gravity is 4.8 g/cm³. A volume average particle diameter of the carrier core of the carrier C2 is 36 m, a saturation magnetization of the carrier core of the carrier C2 is 70 emu/g, and a true specific gravity is 4.8 g/cm³. A volume average particle diameter of the carrier core of the carrier C3 is 36 m, a saturation magnetization of the carrier core of the carrier C3 is 70 emu/g, and a true specific gravity is 4.8 g/cm³.

### <5-3. Measurement Result>

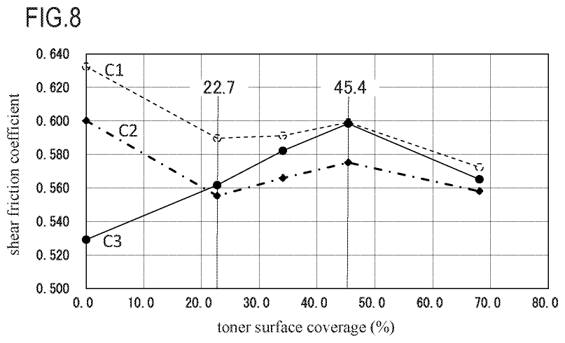

Relationships between the shear friction coefficient and the toner surface coverage of the developers using the carriers C1 to C3, respectively, are shown in FIG. 8. In FIG. 8, a variation in the shear friction coefficient of the developer using the carrier C1 is shown by a broken line, a variation in the shear friction coefficient of the developer using the carrier C2 is shown by a dash-dotted line, and a variation in the shear friction coefficient of the developer using the carrier C3 is shown by a solid line. In addition, measurement results the shear friction coefficients of the developers using the carriers C1 to C3, respectively, are shown in Table 3. Note that when the toner surface coverage is 0%, only the carrier exists in the developer (i.e., the toner does not exist around the carrier). For this reason, in the measurement of the shear friction coefficient when the toner surface coverage is 0%, only the carrier is the measuring object.

TABLE 3

| toner surface coverage | shear friction coefficient | | |
|---|---|---|---|
| (%) | C1 | C2 | C3 |
| 0.0 | 0.632 | 0.600 | 0.529 |
| 22.7 | 0.590 | 0.555 | 0.562 |
| 34.0 | 0.591 | 0.566 | 0.582 |
| 45.4 | 0.599 | 0.575 | 0.598 |
| 68.1 | 0.572 | 0.558 | 0.565 |
| variation width | 0.009 | 0.020 | 0.037 |

In the developer using the carrier C1, within the range where the toner surface coverage is 22.7% or more and 45.4% or less (i.e., in the second state), a variation width of the shear friction coefficient of the developer was 0.02 or less. Specifically, in the developer using the carrier C1, within the range where the toner surface coverage is 22.7% or more and 45.4% or less, the shear friction coefficient of the developer had a maximum value of 0.599 and a minimum value of 0.590. A difference between the maximum value and the minimum value (i.e., the variation width of the shear friction coefficient of the developer) is 0.009 (=0.599-0.590).

In the developer using the carrier C2, within the range where the toner surface coverage is 22.7% or more and 45.4% or less (i.e., in the second state), a variation width of the shear friction coefficient of the developer was 0.02 or less. Specifically, in the developer using carrier C2, within the range where the toner surface coverage is 22.7% or more and 45.4% or less, the shear friction coefficient of the developer had a maximum value of 0.575 and a minimum value of 0.555. A difference between the maximum value and the minimum value (i.e., the variation width of the shear friction coefficient of the developer) is 0.020 (=0.575-0.555).

In the developer using the carrier C3, within the range where the toner surface coverage is 22.7% or more and 45.4% or less (i.e., in the second state), a variation width of the shear friction coefficient of the developer was more than 0.02. Specifically, in the developer using the carrier C3, within the range where the toner surface coverage is 22.7% or more and 45.4% or less, the shear friction coefficient of the developer had a maximum value of 0.598 and a minimum value of 0.562. A difference between the maximum value and the minimum value (i.e., the variation width of the shear friction coefficient of the developer) is 0.037 (=0.598-0.562).

From the above results, it was confirmed that it is possible to decrease the variation width of the shear friction coefficient of the developer, within the range where the toner surface coverage is 22.7% or more and 45.4% or less, by using the silicone coated developer (the carrier C1 or C2), than by using the fluorine coated developer (the carrier C3).

Note that the developer using the carrier C1 and the developer using the carrier C2 are each the silicone coated developer, and that the variation width of the shear friction coefficient of the developer was smaller when using the carrier C1 than when using the carrier C2. From this result, it can be said that the shear friction coefficient of the developer can be adjusted by changing the particle diameter of the carrier, or the like.

### 6. Magnetic Force Reversal Region of Developing Roller

The developer separating part of the developing roller 31 generates a repulsive magnetic field, because it is sandwiched between magnetic forces of the same polarity (the first magnetic pole S1 and the second magnetic pole S2). Due to this generation of the repulsive magnetic field, there is a magnetic force reversal region in which a magnetic force of the developer separating part (a resultant force of a vertical magnetic force and a horizontal magnetic force) increases, as being apart from the developer carrying surface 31S in the normal direction. In other words, the developer separating part has the magnetic force reversal region.

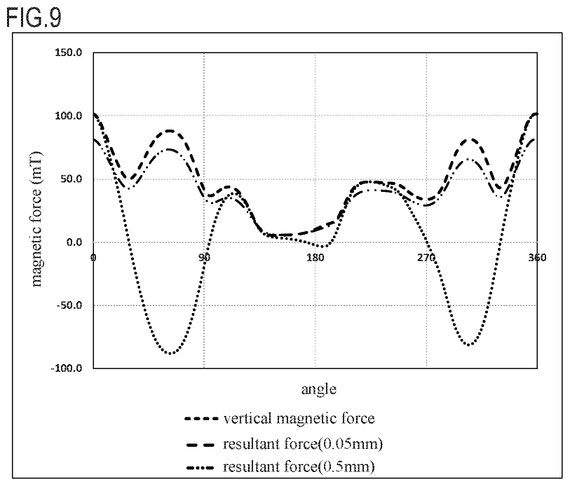

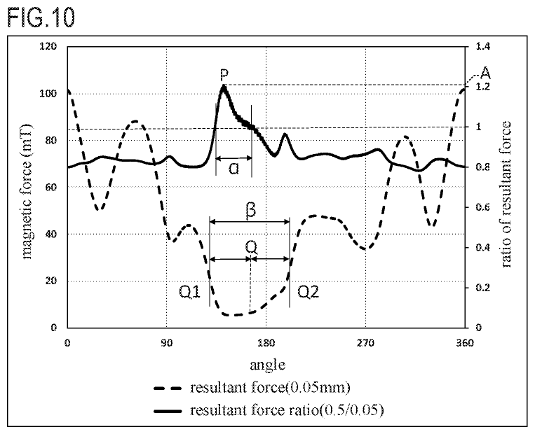

This magnetic force reversal region will be described specifically with reference to FIGS. 9 and 10. FIGS. 9 and 10 are graphs illustrating a magnetic force distribution of the developing roller 31.

In FIGS. 9 and 10, the horizontal axis represents an angle of the magnetic pole (FIG. 2 see), and the left side vertical axis represents a magnetic force (mT). In the graph, a dot line indicates a measured value of the vertical magnetic force. In the graph, a broken line (referred to as “resultant force (0.05 mm)”) is a measured value of the resultant force of the vertical magnetic force and the horizontal magnetic force at a position apart by 0.05 mm from the developer carrying surface 31S in the normal direction. In the graph, a two-dot-dash line (referred to as “resultant force (0.5 mm)”) is a measured value of the resultant force of the vertical magnetic force and the horizontal magnetic force at a position apart by 0.5 mm from the developer carrying surface 31S in the normal direction.

Note that measurement of the vertical magnetic force and the horizontal magnetic force was performed using an automatic magnetic field mapping device (manufactured by NIHON DENJI SOKKI CO., LTD.), i.e., a magnet analyzer 6800ROLL2. In this measurement device, a sensor center position of the horizontal magnetic force is set at a position apart from a sensor center position of the vertical magnetic force by 1.5 mm from the developer carrying surface 31S in the normal direction, but the measured values are regarded as measurement results at the same position.

In addition, the right side vertical axis in FIG. 10 represents a ratio of the resultant force of the vertical magnetic force and the horizontal magnetic force at a position apart by 0.5 mm from the developer carrying surface 31S in the normal direction, to the resultant force of the vertical magnetic force and the horizontal magnetic force at a position apart by 0.05 mm from the developer carrying surface 31S in the normal direction (=“resultant force of vertical magnetic force and horizontal magnetic force of developer separating part at position apart by 0.5 mm”/“resultant force of vertical magnetic force and horizontal magnetic force of developer separating part at position apart by 0.05 mm”). This resultant force ratio is indicated by a solid line (referred to as “resultant force ratio (0.5/0.05)”) in the graph. In the following description, the ratio of the resultant force of the vertical magnetic force and the horizontal magnetic force of the developer separating part at a position apart by 0.5 mm from the developer carrying surface 31S in the normal direction, to the resultant force of the vertical magnetic force and the horizontal magnetic force of the developer separating part at a position apart by 0.05 mm from the developer carrying surface 31S in the normal direction, is simply referred to as the resultant force ratio.

Normally, the resultant force at the position apart by 0.5 mm is smaller than the resultant force at the position apart by 0.05 mm in the normal direction from the developer carrying surface 31S, and the resultant force ratio is less than 1. However, in the developer separating part, there is a region where the resultant force at the position apart by 0.5 mm is larger than the resultant force at the position apart by 0.05 mm in the normal direction from the developer carrying surface 31S (a region where the resultant force ratio is 1 or more). In other words, there is a region where the resultant force is increased as being apart from the developer carrying surface 31S in the normal direction. This region is the magnetic force reversal region.

In the magnetic force reversal region, the developer DP is easily separated from the developer carrying surface 31S. If the developer DP is easily separated from the developer carrying surface 31S, it means that the developer DP is hardly adhered to the developer carrying surface 31S.

Hereinafter, the magnetic force reversal region is described in more detail.

First, a relationship among the first magnetic pole S1, the second magnetic pole S2, and the magnetic force reversal region is described.

If an end position of the magnetic force reversal region on the first magnetic pole S1 side is far from the first magnetic pole S1, accumulation of the developer DP increases at the position of the first magnetic pole S1. In other words, mixing of the developer DP on the developer carrying surface 31S is promoted. In this way, the toner concentration can be easily equalized on the developer carrying surface 31S. However, if the accumulated amount of the developer on the developer carrying surface 31S increases, a driving torque of the development sleeve 310 is increased.

If an end position of the magnetic force reversal region on the second magnetic pole S2 side is close to the second magnetic pole S2, the area of attracting the developer DP to the developer carrying surface 31S is decreased, and accumulation of the developer DP around the regulation gap is decreased. In this case, a variation in the supply amount of the developer DP to the developer carrying surface 31S can easily affect the unevenness of image density.

Next, a relationship between the configuration (function) of the second magnetic pole S2 and the magnetic force reversal region is described. In the following description, the configuration of the second magnetic pole S2, in which the second magnetic pole S2 has both functions of the catching pole and the regulation pole, is referred to as an integrated configuration, while the configuration of the second magnetic pole S2, in which the regulation pole is disposed separately from the second magnetic pole S2 (the catching pole), is referred to as a discrete configuration.

In the case where the second magnetic pole S2 has the integrated configuration, if the magnetic force reversal region is close to the second magnetic pole S2, it is difficult for the second magnetic pole S2 to stably supply the developer DP to the developer carrying surface 31S, which causes unevenness of image density. For this reason, in the case where the second magnetic pole S2 has the integrated configuration, it is preferred to set the magnetic force reversal region apart from the second magnetic pole S2, so that the second magnetic pole S2 can stably supply the developer DP to the developer carrying surface 31S.

In the case where the second magnetic pole S2 has the discrete configuration, if the magnetic force reversal region is far from the second magnetic pole S2, the supply of the developer DP to the developer carrying surface 31S by the second magnetic pole S2 is increased, and hence accumulation of the developer DP at the position of the second magnetic pole S2 is increased. In this way, the driving torque of the development sleeve 310 is increased, or deterioration of the developer DP is promoted. These cause unevenness of image density. For this reason, in the case where the second magnetic pole S2 has the discrete configuration, it is preferred to set the magnetic force reversal region close to the second magnetic pole S2, so that the supply of the developer DP to the developer carrying surface 31S by the second magnetic pole S2 will not excessively increase.

Here, the distance of the magnetic force reversal region in the circumferential direction is shorter in the case where the second magnetic pole S2 has the discrete configuration, than in the case where the same has the integrated configuration. In addition, as the diameter of the development sleeve 310 is smaller, the distance of the magnetic force reversal region in the circumferential direction is shorter. For this reason, it is necessary to design in accordance with specification of the developing roller 31 (the diameter, the magnetic pole configuration, and the like). The circumferential direction means a circumferential direction of a circle having the center at a rotation axis of the development sleeve 310, and is a direction along the outer peripheral surface of the development sleeve 310.

In addition, easiness of separation of the developer DP from the developer carrying surface 31S changes depending on the shear friction coefficient of the developer DP. If the shear friction coefficient of the developer DP is high, the developer DP is hardly separated from the developer carrying surface 31S. If the shear friction coefficient of the developer DP is low, the developer DP is easily separated from the developer carrying surface 31S. For this reason, it is necessary to design in accordance with the type of the developer DP (e.g., a silicone coated developer, a fluorine coated developer, or the like).

Hereinafter, specific description is given below. In the following description, a position on the developer carrying surface 31S of the developer separating part, at which the resultant force ratio is maximum is referred to as a position P (hereinafter, referred to as a peak position P). A position on the developer carrying surface 31S of the developer separating part on the first magnetic pole S1 side, at which the resultant force of the vertical magnetic force and the horizontal magnetic force of the developer separating part is 20 mT is referred to as a position Q1. A position on the developer carrying surface 31S of the developer separating part on the second magnetic pole S2 side, at which the resultant force of the vertical magnetic force and the horizontal magnetic force of the developer separating part is 20 mT is referred to as a position Q2. An intermediate position between the position Q1 and the position Q2 in the circumferential direction is referred to as a position Q (hereinafter, referred to as an intermediate position Q). In addition, for convenience's sake, the upstream side in the rotation direction of the development sleeve 310 is simply referred to as the upstream side, and the downstream side in the rotation direction of the development sleeve 310 is simply referred to as the downstream side.

If the peak position P is on the upstream side of the intermediate position Q, the distance of the magnetic force reversal region in the circumferential direction becomes short, but the separation property of the developer DP from the developer carrying surface 31S at the developer separating part is improved. In addition, when the peak position P is moved to the upstream side of the intermediate position Q, there is no magnetic force reversal region in the vicinity of the second magnetic pole S2. For this reason, supply of the developer DP to the developer carrying surface 31S by the second magnetic pole S2 is stabilized. In this way, if the peak position P is on the upstream side of the intermediate position Q, it is preferred that the second magnetic pole S2 have the integrated configuration.

Note that when the peak position P is moved to the upstream side of the intermediate position Q, so as to get a profile of the resultant force ratio, the resultant force ratio is rapidly changed at the peak position P. Therefore, by moving the peak position P to the upstream side of the intermediate position Q, separation property of the developer DP from the developer carrying surface 31S at the developer separating part can be improved.

If the peak position P is close to the intermediate position Q, or if the peak position P is on the downstream side of the intermediate position Q, the distance of the magnetic force reversal region in the circumferential direction becomes long. In other words, the magnetic force reversal region exists close to the second magnetic pole S2. For this reason, supply performance of the developer DP to the developer carrying surface 31S by the second magnetic pole S2 is decreased. In this way, if the peak position P is close to the intermediate position Q, or if the peak position P is on the downstream side of the intermediate position Q, it is preferred that the second magnetic pole S2 have the discrete configuration.

In consideration of these, in this embodiment, the developing roller 31 is configured to satisfy the following inequalities (F1) to (F4). In the following inequalities (F1) to (F4), a value of the resultant force ratio at the peak position P is “A”. A distance in the circumferential direction on the developer carrying surface 31S, from the position Q1 on the first magnetic pole S1 side to the position Q2 on the second magnetic pole S2 side of the magnetic force reversal region, is α (mm). A distance in the circumferential direction between the position Q1 and the position Q2 is β (mm). A distance in the circumferential direction between the position P and the position Q is γ (mm). Note that in the following inequalities (F1) to (F4), γ has a positive value when the position Q is on the upstream side of the position P in the rotation direction of the development sleeve 310, and γ has a negative value when the position Q is on the downstream side of the position P in the rotation direction of the development sleeve 310. In addition, if the magnetic force reversal region is divided into a plurality of regions between the position Q1 and the position Q2 in the circumferential direction, the sum of distances of the divided magnetic force reversal regions is the distance α (mm).

α−(18.9×(γ/β)²+20.8×(γ/β))>6 (F1)

α−(18.9×(γ/β)²+20.8×(γ/β))>7 (F2)

A/α+0.8334×(γ/β)≤0.275 (F3)

A/α+0.8334×(γ/β)≤0.243 (F4)

If the variation width of the shear friction coefficient of the developer DP is 0.02 or less within the range where the toner surface coverage of the developer DP is 22.7% or more and 45.4% or less, i.e., if the developer DP is the silicone coated developer, it is configured to satisfy the inequality (F1) and the inequality (F3).

If the variation width of the shear friction coefficient of the developer DP is more than 0.02 and 0.037 or less within the range where the toner surface coverage of the developer DP is 22.7% or more and 45.4% or less, i.e., if the developer DP is the fluorine coated developer, it is configured to satisfy the inequality (F2) and the inequality (F4).

If the developer DP is the silicone coated developer, by configuring the developing roller 31 to satisfy the inequality (F1) and the inequality (F3), the separation performance of the developer DP from the developer carrying surface 31S is improved (i.e., a separation failure of the developer DP from the developer carrying surface 31S can be suppressed). When the separation performance is improved, unevenness of image density can be suppressed.

In addition, if the developer DP is the fluorine coated developer, by configuring the developing roller 31 to satisfy the inequality (F2) and the inequality (F4), the separation performance of the developer DP from the developer carrying surface 31S is improved (i.e., a separation failure of the developer DP from the developer carrying surface 31S can be suppressed). When the separation performance is improved, unevenness of image density can be suppressed.

### 7. Confirmation Experiment

Hereinafter, an experiment is described, which was performed for checking the above effects of this embodiment. In the confirmation experiment, printing was actually performed, and states of printed images were checked.

In the confirmation experiment, the above toner T was used. In addition, in the confirmation experiment, the above carriers C1 to C3 were used. In other words, in the confirmation experiment, three types of developers, i.e., the developer containing the toner T and the carrier C1, the developer containing the toner T and the carrier C2, and the developer containing the toner T and the carrier C3 were used. The toner surface coverage of the three types of developers is 22.7% or more and 45.4% or less. Then, Experiments 1 to 16 were performed using the three types of developers.

In Experiments 1 to 16, an image forming apparatus (Taskalfa6054Ci (a modified machine)) manufactured by KYOCERA Document Solutions Inc. was used as an evaluation machine. However, the configuration of the developing roller is different among Experiments. The configurations of the developing rollers used in Experiments 1 to 16 are shown in Table 4.

TABLE 4

| | roller | | α | β | γ | | | magnetic pole |
|---|---|---|---|---|---|---|---|---|
| No. | (mm) | A | (mm) | (mm) | (mm) | γ / β | A/ α | configuration |
| 1 | 14 | 1.51 | 4.9 | 14.5 | −2.9 | −0.20 | 0.31 | integrated |
| 2 | 16 | 1.21 | 3.3 | 9.9 | −3.4 | −0.34 | 0.37 | integrated |
| 3 | 16 | 1.67 | 10.1 | 10.2 | 0.7 | 0.08 | 0.17 | discrete |
| 4 | 20 | 1.27 | 11.4 | 14.8 | 2.07 | 0.14 | 0.11 | discrete |
| 5 | 16 | 1.37 | 2.5 | 13.0 | −4.8 | −0.37 | 0.55 | integrated |
| 6 | 16 | 1.46 | 3.1 | 11.1 | −3.1 | −0.28 | 0.47 | integrated |
| 7 | 18 | 1.52 | 9.5 | 15.0 | 1.5 | 0.10 | 0.16 | discrete |
| 8 | 20 | 1.70 | 5.5 | 16.5 | −1.5 | −0.09 | 0.31 | discrete |
| 9 | 14 | 1.10 | 2.1 | 12.3 | −3.8 | −0.31 | 0.52 | integrated |
| 10 | 16 | 1.33 | 2.8 | 11.8 | −2.9 | −0.25 | 0.48 | integrated |
| 11 | 16 | 1.59 | 5.3 | 20.0 | −1.0 | −0.05 | 0.30 | discrete |
| 12 | 18 | 1.67 | 7.3 | 10.5 | 0.58 | 0.06 | 0.23 | discrete |
| 13 | 20 | 1.28 | 2.5 | 13.9 | −2.5 | −0.18 | 0.51 | integrated |
| 14 | 16 | 1.56 | 5.2 | 10.0 | −0.2 | −0.02 | 0.30 | discrete |
| 15 | 14 | 1.6 | 6.1 | 3.3 | 0.1 | 0.03 | 0.26 | discrete |
| 16 | 16 | 1.77 | 8.1 | 16.4 | 1.8 | 0.11 | 0.22 | discrete |

In the above Table 4, the roller corresponds to a diameter of the developing roller (development sleeve). The distance α, the distance β, and the distance γ correspond to “α”, “β”, and “γ” in the above inequalities (F1) to (F4), respectively. The resultant force ratio A corresponds to “A” in the above inequality (F3) and the inequality (F4).

In addition, in the above Table 4, a value of “γ/β” is zero when the peak position P coincides the intermediate position Q. A value of “γ/β” is larger in the negative side as the peak position P is farther from intermediate position Q on the upstream side (as the peak position P is closer to the first magnetic pole S1), while it is larger in the positive side as the peak position P is farther from the intermediate position Q on the downstream side (as the peak position P is closer to the second magnetic pole S2). A value of “A/α” is larger as the variation of the resultant force ratio at the peak position P is steeper.

In addition, in the above Table 4, the item “magnetic pole configuration” is a configuration of the second magnetic pole S2. In Table 4, if the second magnetic pole S2 has the integrated configuration, it is shown as “integrated type”, and if the second magnetic pole S2 has the discrete configuration, it is shown as “discrete type”.

In Experiments 1, 2, 5, 6, 9, 10, and 13, the second magnetic pole S2 was set to have the integrated configuration, while in other Experiments, the second magnetic pole S2 was set to have the discrete configuration. In other words, if the value of “γ/β” is larger than “−0.09”, the second magnetic pole S2 was set to have the discrete configuration, while if the value of “γ/β” is smaller than “−0.18”, the second magnetic pole S2 was set to have the integrated configuration.

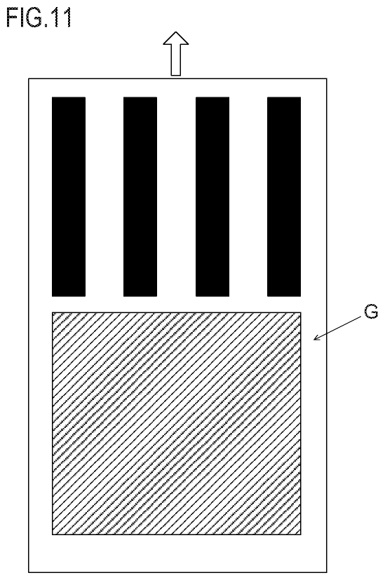

In each of Experiments 1 to 16, a magenta toner was used so as to print on 100,000 sheets with a coverage rate of 5%, and five sheets of a test image (see FIG. 11) including a half image G printed with 35% were obtained for every 10,000 printed sheets. In addition, for each of the five sheets of the half image G obtained for every 10,000 printed sheets, a luminance deviation and an average luminance were acquired, and a maximum value of luminance deviation/average luminance was calculated. Further, an average value of the maximum values of the five sheets of the half image G was calculated, as a value indicating the unevenness of image density. As the value indicating the unevenness of image density is smaller, a degree of unevenness of image density is lower (better).

Note that in the measurement of density unevenness of the half image G, the evaluation target image was taken into image analysis software (“ImagePro” manufactured by MediaCybernetics Company) and is converted into grayscale, and then the image was processed by a low-pass filter, so as to remove fine noise. After that, the processed half image G was divided into 500 (10×50) regions. In addition, further, luminance deviation and average luminance were measured for each of the 500 regions, and a value of luminance deviation/average luminance was calculated.

Further, in each of Experiments 1 to 16, a maximum value of the values of the unevenness of image density (the average value of the maximum values of the five sheets of the half image G) obtained in individual times was obtained as the evaluation target. Evaluation criteria are shown as follows. The evaluation result A is best, the evaluation result B is good, and the evaluation result C is a level without a problem. On the other hand, the evaluation result D is a level having a problem, and the evaluation result E is a worst level (a level having a problem).
A: The value of the unevenness of image density is 0.023 or less.
B: The value of the unevenness of image density is 0.024 or more and 0.027 or less.
C: The value of the unevenness of image density is 0.028 or more and 0.031 or less.
D: The value of the unevenness of image density is 0.032 or more and 0.035 or less.
E: The value of the unevenness of image density is 0.036 or more.

Note that in each of Confirmation Experiments 1 to 16, all the developer containing the carrier C1, the developer containing the carrier C2, and the developer containing the carrier C3 were used so as to perform printing. In other words, in each of Confirmation Experiments 1 to 16, three types of printing using different developers were performed on 100,000 sheets each. Then, the unevenness of image density was determined for each of the three types of printing. The result is shown in Table 5.

TABLE 5

| | | | unevenness of image density | | | evaluation | | |
|---|---|---|---|---|---|---|---|---|
| | calculated value | | (measured value) | | | result | | |
| No. | first | second | C1 | C2 | C3 | C1 | C2 | C3 |
| 1 | 8.3 | 0.141 | 0.021 | 0.024 | 0.025 | A | B | B |
| 2 | 8.2 | 0.079 | 0.022 | 0.024 | 0.026 | A | B | B |
| 3 | 8.3 | 0.232 | 0.022 | 0.026 | 0.027 | A | B | B |
| 4 | 8.1 | 0.228 | 0.022 | 0.025 | 0.027 | A | B | B |
| 5 | 7.6 | 0.239 | 0.025 | 0.026 | 0.028 | B | B | C |
| 6 | 7.4 | 0.238 | 0.026 | 0.027 | 0.029 | B | B | C |
| 7 | 7.2 | 0.243 | 0.025 | 0.026 | 0.03 | B | B | C |
| 8 | 7.2 | 0.234 | 0.027 | 0.027 | 0.031 | B | B | C |
| 9 | 6.7 | 0.265 | 0.029 | 0.028 | 0.032 | C | C | D |
| 10 | 6.8 | 0.270 | 0.028 | 0.03 | 0.033 | C | C | D |
| 11 | 6.3 | 0.258 | 0.03 | 0.031 | 0.033 | C | C | D |
| 12 | 6.1 | 0.275 | 0.03 | 0.031 | 0.034 | C | C | D |
| 13 | 5.6 | 0.362 | 0.032 | 0.033 | 0.036 | D | D | E |
| 14 | 5.6 | 0.283 | 0.033 | 0.034 | 0.037 | D | D | E |
| 15 | 5.5 | 0.287 | 0.033 | 0.035 | 0.038 | D | D | E |
| 16 | 5.6 | 0.310 | 0.034 | 0.035 | 0.038 | D | D | E |

Table 5 shows a first calculated value and a second calculated value indicating characteristics of the developing roller used in each Experiment. The first calculated value is a value of “α−(18.9×(γ/β)²+20.8×(γ/β))” in the above inequalities (F1) and (F2). The second calculated value is a value of “A/α+0.8334×(γ/β)” in the above inequalities (F3) and (F4).

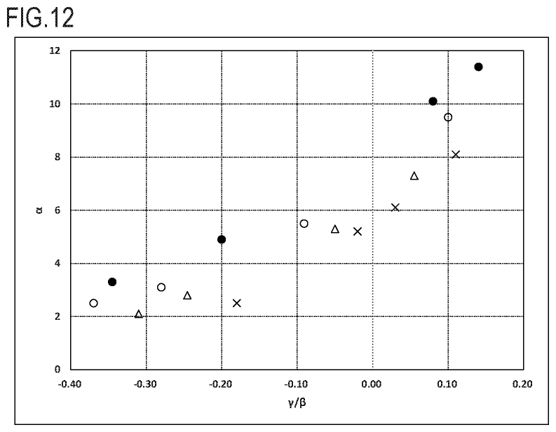

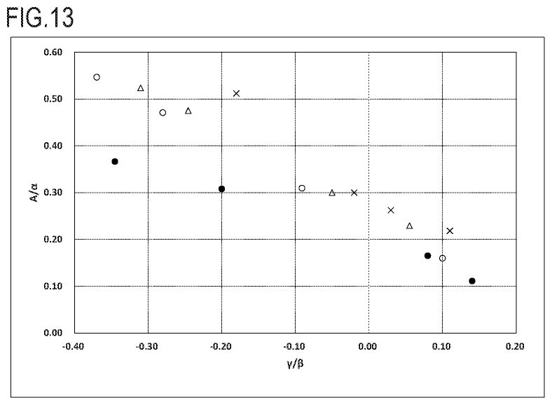

The experiment result in the case of using the developer containing the carrier C1 is also shown in FIG. 12 and FIG. 13.

FIG. 12 is a graph in which the vertical axis represents “α”, and the horizontal axis represents “γ/β”. FIG. 13 is a graph in which the vertical axis represents “A/α”, and the horizontal axis represents “γ/β”. In FIG. 12 and FIG. 13, the experiment results using the developer containing the carrier C1 are plotted. Specifically, a black circle mark indicates the evaluation result A, a single circle mark indicates the evaluation result B, a triangle mark indicates the evaluation result C, and an x mark indicates the evaluation result D.

Hereinafter, the experiment result is described in detail.

First, according to FIG. 12, even if a value of “α” (the distance of the magnetic force reversal region in the circumferential direction) is small, if a value of “γ/β” is set to be small, unevenness of image density is suppressed. As the peak position P is closer to the first magnetic pole S1, a value of “γ/β” is smaller (i.e., a value of “γ/β” is larger in the negative side). From this point, it can be said that even if the distance of the magnetic force reversal region in the circumferential direction is short, it is sufficient to set the peak position P to be close to the first magnetic pole S1.

In addition, the first calculated value indicates the intercept in FIG. 12. In other words, as the first calculated value is larger, the distance of the magnetic force reversal region in the circumferential direction is longer. Note that if a value of “γ/β” is the same, it is preferred to set the first calculated value to be larger.

Here, in the experiment using the silicone coated developer (the carriers C1 and C2), when the first calculated value was more than 6.0, the evaluation result was “C” or better. In this way, when using the silicone coated developer, i.e., when using the developer whose variation width of the shear friction coefficient is 0.02 or less within the range where the toner surface coverage is 22.7% or more and 45.4% or less, it can be said that unevenness of image density can be suppressed, by configuring the developing roller to satisfy the above inequality (F1).

In addition, in the experiment using the carrier C1 or C2, the first calculated value was larger than 7.0, and the evaluation result was “B” or better. In this way, when using the developer whose variation width of the shear friction coefficient is 0.02 or less within the range where the toner surface coverage is 22.7% or more and 45.4% or less, it is preferred that a value of “α−(18.9×(γ/β)²+20.8×(γ/β))” be larger than 7.0.

Further, in the experiment using the carrier C1 (i.e., in the experiment using the developer whose variation width of the shear friction coefficient is 0.009 or less within the range where the toner surface coverage is 22.7% or more and 45.4% or less), the first calculated value was larger than 8.0, and hence the evaluation result was “A”. In this way, when using the developer whose variation width of the shear friction coefficient is 0.009 or less within the range where the toner surface coverage is 22.7% or more and 45.4% or less, it is preferred that a value of “α−(18.9×(γ/β)²+20.8×(γ/β))” be larger than 8.0.

In addition, in the experiment using the fluorine coated developer (the carrier C3), the first calculated value was larger than 7.0, and the evaluation result was “C” or better. In this way, when using the fluorine coated developer, i.e., when using the developer whose variation width of the shear friction coefficient is more than 0.02 but 0.037 or less within the range where the toner surface coverage is 22.7% or more and 45.4% or less, it can be said that unevenness of image density can be suppressed by configuring the developing roller to satisfy the above inequality (F2).

Note that in the experiment using the carrier C3, the first calculated value was larger than 8.0, and hence the evaluation result was “B”. In this way, when using the developer whose variation width of the shear friction coefficient is 0.037 or less within the range where the toner surface coverage is 22.7% or more and 45.4% or less, it is preferred that a value of “α−(18.9×(γ/β)²+20.8×(γ/β))” be larger than 8.0.

Next, according to FIG. 13, by increasing a value of “A/α” as the peak position P is closer to the first magnetic pole S1 (i.e., as a value of “γ/β” is smaller), unevenness of image density is suppressed. To increase a value of “A/α” means to steeply change the resultant force ratio at the peak position P. From this point, it can be said that when the peak position P approaches the second magnetic pole S2 (i.e., when a value of “γ/β” increases), it is sufficient to increase a value of “α” so that a value of “A/α” is decreased. Note that if “γ/β” has the same value, it is preferred to increase more the distance of the magnetic force reversal region in the circumferential direction (i.e., to decrease more a value of “A/α”).

Here, in the experiment using the silicone coated developer (the carrier C1 or C2), when the second calculated value is 0.275 or less, the evaluation result was “C” or better. In this way, when using the silicone coated developer, i.e., when using the developer whose variation width of the shear friction coefficient is 0.02 or less within the range where the toner surface coverage is 22.7% or more and 45.4% or less, it can be said that unevenness of image density can be suppressed by configuring the developing roller to satisfy the above inequality (F3).

Note that in the experiment using the carrier C1 or C2, the second calculated value was 0.243 or less, and hence the evaluation result was “B” or better. In this way, when using the developer whose variation width of the shear friction coefficient is 0.02 or less within the range where the toner surface coverage is 22.7% or more and 45.4% or less, it is preferred that a value of “A/α+0.8334×(γ/β)” be 0.243 or less.

Further, in the experiment using the carrier C1 (i.e., in the experiment using the developer whose variation width of the shear friction coefficient is 0.009 or less within the range where the toner surface coverage is 22.7% or more and 45.4% or less), the second calculated value was 0.232 or less, and hence the evaluation result was “A”. In this way, when using the developer whose variation width of the shear friction coefficient is 0.009 or less within the range where the toner surface coverage is 22.7% or more and 45.4% or less, it is preferred that a value of “A/α+0.8334×(γ/β)” be 0.232 or less.

In the experiment using the fluorine coated developer (the carrier C3), the second calculated value was 0.243 or less, and hence the evaluation result was “C” or better. In this way, when using the fluorine coated developer, i.e., when using the developer whose variation width of the shear friction coefficient is more than 0.02 but 0.037 or less within the range where the toner surface coverage is 22.7% or more and 45.4% or less, it can be said that unevenness of image density can be suppressed by configuring the developing roller to satisfy the above inequality (F4).

Further, in the experiment using the carrier C3, the second calculated value was 0.232 or less, and hence the evaluation result was “B”. In this way, when using the developer whose variation width of the shear friction coefficient is more than 0.02 but 0.037 or less within the range where the toner surface coverage is 22.7% or more and 45.4% or less, it is preferred that a value of “A/α+0.8334×(γ/β)” be 0.232 or less.

The embodiment disclosed this time is merely an example in every aspect, and should not be considered as a limitation. The scope of the present disclosure is defined not by the above description of the embodiment but by the claims, and further it includes all modifications within meaning and scope equivalent to the claims.

What is claimed is:

1. A developing device comprising a developing roller having a developer carrying surface for carrying a two-component developer containing toner particles and carrier particles, so as to supply the toner particles in the two-component developer carried on the developer carrying surface to an electrostatic latent image at a development position, thereby developing the electrostatic latent image, wherein
the developing roller includes
a shaft extending in a predetermined direction,
a magnet fixed to an outer peripheral surface of the shaft, so as to have a plurality of magnetic poles in a circumferential direction of the shaft, and
a development sleeve as a cylindrical member in which the shaft is inserted, the development sleeve having an outer peripheral surface of the cylindrical member as the developer carrying surface, and being supported in a rotatable manner about the shaft,
the magnet including, as the magnetic poles, at least
a first magnetic pole disposed on the downstream side of the development position in the rotation direction of the development sleeve, and
a second magnetic pole disposed on the downstream side of the first magnetic pole in the rotation direction of the development sleeve, so as to have the same polarity as the first magnetic pole, thereby attracting the two-component developer to the developer carrying surface,
the developing roller has a part from the first magnetic pole to the second magnetic pole on the downstream side in the rotation direction of the development sleeve, as a developer separating part for allowing the two-component developer to separate from the developer carrying surface,
the developer separating part has a magnetic force reversal region, in which a resultant force of a vertical magnetic force and a horizontal magnetic force of the developer separating part increases as being apart from the developer carrying surface in the normal direction,
supposing that position P represents a position on the developer carrying surface, at which a ratio of the resultant force of the vertical magnetic force and the horizontal magnetic force of the developer separating part at 0.5 mm apart from the developer carrying surface in the normal direction, to the resultant force of the vertical magnetic force and the horizontal magnetic force of the developer separating part at 0.05 mm apart from the developer carrying surface in the normal direction, becomes maximum,
supposing that position Q represents an intermediate position in the circumferential direction between a position Q1 on the developer carrying surface, at which the resultant force of the vertical magnetic force and the horizontal magnetic force of the developer separating part is 20 mT, on the first magnetic pole side of the developer separating part, and a position Q2 on the developer carrying surface, at which the resultant force of the vertical magnetic force and the horizontal magnetic force of the developer separating part is 20 mT, on the second magnetic pole side of the developer separating part,
supposing that a distance in the circumferential direction on the developer carrying surface, from the position Q1 on the first magnetic pole side to the position Q2 on the second magnetic pole side of the magnetic force reversal region, is α (mm),
supposing that a distance between the position Q1 and the position Q2 in the circumferential direction is β (mm),
supposing that a distance between the position P and the position Q in the circumferential direction is γ (mm),
supposing that γ has a positive value when the position Q is on the upstream side of the position P in the rotation direction of the development sleeve, and that γ has a negative value when the position Q is on the downstream side of the position P in the rotation direction of the development sleeve, then the following inequality (F1) is satisfied, and
when the inequality (F1) is satisfied, a variation width of a shear friction coefficient of the two-component developer is 0.02 or less, within a range where a surface coverage of toner particles with respect to one carrier particle is 22.7% or more and 45.4% or less.
α−(18.9×(γ/β)²+20.8×(γ/β))>6 (F1)

2. A developing device comprising a developing roller having a developer carrying surface for carrying a two-component developer containing toner particles and carrier particles, so as to supply the toner particles in the two-component developer carried on the developer carrying surface to an electrostatic latent image at a development position, thereby developing the electrostatic latent image, wherein
the developing roller includes
a shaft extending in a predetermined direction,
a magnet fixed to an outer peripheral surface of the shaft, so as to have a plurality of magnetic poles in a circumferential direction of the shaft, and
a development sleeve as a cylindrical member in which the shaft is inserted, the development sleeve having an outer peripheral surface of the cylindrical member as the developer carrying surface, and being supported in a rotatable manner about the shaft,
the magnet including, as the magnetic poles, at least
a first magnetic pole disposed on the downstream side of the development position in the rotation direction of the development sleeve, and
a second magnetic pole disposed on the downstream side of the first magnetic pole in the rotation direction of the development sleeve, so as to have the same polarity as the first magnetic pole, thereby attracting the two-component developer to the developer carrying surface,
the developing roller has a part from the first magnetic pole to the second magnetic pole on the downstream side in the rotation direction of the development sleeve, as a developer separating part for allowing the two-component developer to separate from the developer carrying surface,
the developer separating part has a magnetic force reversal region, in which a resultant force of a vertical magnetic force and a horizontal magnetic force of the developer separating part increases as being apart from the developer carrying surface in the normal direction,
supposing that position P represents a position on the developer carrying surface, at which a ratio of the resultant force of the vertical magnetic force and the horizontal magnetic force of the developer separating part at 0.5 mm apart from the developer carrying surface in the normal direction, to the resultant force of the vertical magnetic force and the horizontal magnetic force of the developer separating part at 0.05 mm apart from the developer carrying surface in the normal direction, becomes maximum,
supposing that position Q represents an intermediate position in the circumferential direction between a position Q1 on the developer carrying surface, at which the resultant force of the vertical magnetic force and the horizontal magnetic force of the developer separating part is 20 mT, on the first magnetic pole side of the developer separating part, and a position Q2 on the developer carrying surface, at which the resultant force of the vertical magnetic force and the horizontal magnetic force of the developer separating part is 20 mT, on the second magnetic pole side of the developer separating part,
supposing that a distance in the circumferential direction on the developer carrying surface, from the position Q1 on the first magnetic pole side to the position Q2 on the second magnetic pole side of the magnetic force reversal region, is α (mm),
supposing that a distance between the position Q1 and the position Q2 in the circumferential direction is β (mm),
supposing that a distance between the position P and the position Q in the circumferential direction is γ (mm),
supposing that γ has a positive value when the position Q is on the upstream side of the position P in the rotation direction of the development sleeve, and that γ has a negative value when the position Q is on the downstream side of the position P in the rotation direction of the development sleeve, then the following inequality (F2) is satisfied, and
when the inequality (F2) is satisfied, a variation width of the shear friction coefficient of the two-component developer is 0.037 or less, within the range where a surface coverage of the toner particles with respect to one carrier particle is 22.7% or more and 45.4% or less.
α−(18.9×(γ/β)²+20.8×(γ/β))>7 (F2)

3. A developing device comprising a developing roller having a developer carrying surface for carrying a two-component developer containing toner particles and carrier particles, so as to supply the toner particles in the two-component developer carried on the developer carrying surface to an electrostatic latent image at a development position, thereby developing the electrostatic latent image, wherein
the developing roller includes
a shaft extending in a predetermined direction,
a magnet fixed to an outer peripheral surface of the shaft, so as to have a plurality of magnetic poles in a circumferential direction of the shaft, and
a development sleeve as a cylindrical member in which the shaft is inserted, the development sleeve having an outer peripheral surface of the cylindrical member as the developer carrying surface, and being supported in a rotatable manner about the shaft,
the magnet including, as the magnetic poles, at least
a first magnetic pole disposed on the downstream side of the development position in the rotation direction of the development sleeve, and
a second magnetic pole disposed on the downstream side of the first magnetic pole in the rotation direction of the development sleeve, so as to have the same polarity as the first magnetic pole, thereby attracting the two-component developer to the developer carrying surface,
the developing roller has a part from the first magnetic pole to the second magnetic pole on the downstream side in the rotation direction of the development sleeve, as a developer separating part for allowing the two-component developer to separate from the developer carrying surface,
the developer separating part has a magnetic force reversal region, in which a resultant force of a vertical magnetic force and a horizontal magnetic force of the developer separating part increases as being apart from the developer carrying surface in the normal direction,
supposing that position P represents a position on the developer carrying surface, at which a ratio of the resultant force of the vertical magnetic force and the horizontal magnetic force of the developer separating part at 0.5 mm apart from the developer carrying surface in the normal direction, to the resultant force of the vertical magnetic force and the horizontal magnetic force of the developer separating part at 0.05 mm apart from the developer carrying surface in the normal direction, becomes maximum,
supposing that a value of the ratio at the position P is “A”,
supposing that position Q represents an intermediate position in the circumferential direction between a position Q1 on the developer carrying surface, at which the resultant force of the vertical magnetic force and the horizontal magnetic force of the developer separating part is 20 mT, on the first magnetic pole side of the developer separating part, and a position Q2 on the developer carrying surface, at which the resultant force of the vertical magnetic force and the horizontal magnetic force of the developer separating part is 20 mT, on the second magnetic pole side of the developer separating part,
supposing that a distance in the circumferential direction on the developer carrying surface, from the position Q1 on the first magnetic pole side to the position Q2 on the second magnetic pole side of the magnetic force reversal region, is α (mm),
supposing that a distance between the position Q1 and the position Q2 in the circumferential direction is β (mm),
supposing that a distance between the position P and the position Q in the circumferential direction is γ (mm),
supposing that γ has a positive value when the position Q is on the upstream side of the position P in the rotation direction of the development sleeve, and that γ has a negative value when the position Q is on the downstream side of the position P in the rotation direction of the development sleeve, then the following inequality (F3) is satisfied, and
when the inequality (F3) is satisfied, a variation width of the shear friction coefficient of the two-component developer is 0.02 or less, within the range where a surface coverage of the toner particles with respect to one carrier particle is 22.7% or more and 45.4% or less.
A/α+0.8334×(γ/β)≤0.275 (F3)

4. An image forming apparatus comprising the developing device according to claim 1, so as to print an image developed by the developing device on a sheet.

5. An image forming apparatus comprising the developing device according to claim 2, so as to print an image developed by the developing device on a sheet.

6. An image forming apparatus comprising the developing device according to claim 3, so as to print an image developed by the developing device on a sheet.
